(19) United States
(12) Patent Application Publication
(10) Pub. No.: US 2013/0156017 A1
(43) Pub. Date: Jun. 20, 2013

(54) TERMINAL APPARATUS FOR TRANSMITTING OR RECEIVING A SIGNAL INCLUDING PREDETERMINED INFORMATION

(71) Applicant: SANYO ELECTRIC CO., LTD., Osaka (JP)

(72) Inventors: Yoshihiro HORI, Gifu-shi (JP); Yuichi KANAI, Ichinomiya-shi (JP); Makoto NAGAI, Kakamigahara-shi (JP)

(73) Assignee: SANYO ELECTRIC CO., LTD., Osaka (JP)

(21) Appl. No.: 13/770,845

(22) Filed: Feb. 19, 2013

Related U.S. Application Data
(63) Continuation of application No. PCT/JP2011/007151, filed on Dec. 21, 2011.

(30) Foreign Application Priority Data
Dec. 28, 2010 (JP) 2010-293560

(51) Int. Cl. H04J 3/16; H04L 9/32

(52) U.S. Cl. CPC H04J 3/1694; H04L 9/3247
USPC 370/336; 370/252; 380/255

(57) ABSTRACT

A reception unit periodically receives a packet signal from a base station apparatus in each of two or more subframes in a superframe formed by time-multiplexing the subframes. An analysis unit gives a priority order to a subframe receiving the packet signal from the base station apparatus based on the packet signal received in the reception unit. A processing unit preferentially processes the packet signal received in the subframe with a high priority order among the priority orders given in the analysis unit.

### BACKGROUND OF THE INVENTION

1. Field of the Invention

The present invention relates to a communication technique, and particularly to a terminal apparatus for exchanging a signal containing predetermined information.

2. Description of the Related Art

There is discussed a drive assist system for providing road information or intersection information via road-to-vehicle communication in order to prevent collision accidents at the intersections or to reduce traffic jams, or mutually providing vehicle drive information via inter-vehicle communication. With the road-to-vehicle communication, information on the situations of the intersections is communicated between a roadside apparatus and a vehicle-mounted apparatus. With the road-to-vehicle communication, the roadside apparatuses need to be installed on the intersections or on the roads, and thus time and cost therefor increase. To the contrary, with the inter-vehicle communication, or in a form in which information is communicated between the vehicle-mounted apparatuses, the roadside apparatuses do not need to be installed. In this case, for example, current position information is detected by GPS (Global Positioning System) or the like in real-time and the position information is exchanged between the vehicle-mounted apparatuses, so that a determination is made as to on which road the vehicle and other vehicles are positioned to enter the intersection.

Communication is more easily intercepted with wireless communication than with wired communication, and thus confidential communication contents are difficult to secure. When a apparatus is controlled via a network, a spoofing third party can operate it via illegal communication. In order to secure confidential communication contents via the wireless communication, communication data needs to be encrypted and a key used for the encryption needs to be periodically updated. For example, each network apparatus is in an initial state in which only data encrypted with an old encryption key used before the update can be exchanged on the update of the encryption key. Each apparatus can exchange both items of data encrypted with the old encryption key and the updated new encryption key in this state, and the exchange of the data encrypted with the new encryption key transits to the operation-unconfirmed state. Further, each apparatus can exchange the data encrypted with both the old encryption key and the new encryption key, and the exchange of the data encrypted by the new encryption key transits to the operation-confirmed state. Finally, each apparatus sequentially transits to the state in which only the data encrypted with the new encryption key after the completion of the key update can be exchanged.

When a wireless LAN is applied to the inter-vehicle communication, information needs to be transmitted to many terminal apparatuses and thus a signal is desirably transmitted in broadcast. However, at the intersections, an increase in vehicles or an increase in terminal apparatuses causes an increase in traffics, and thus an increase in collisions of packet signals is expected. Consequently, data contained in the packet signal cannot be sent to other terminal apparatus. If the state occurs in the inter-vehicle communication, the purpose to prevent collision accidents at the intersections cannot be achieved. Further, if the road-to-vehicle communication is made in addition to the inter-vehicle communication, various communication forms are employed. At this time, a decrease in mutual impacts between the inter-vehicle communication and the road-to-vehicle communication is required.

In the situation, a message authentication code (MAC) generated in common key cryptosystem or an electronic signature generated in public key cryptosystem is attached to a message in order to prevent spoofing or data falsification. The message with a message authentication code or electronic signature is verified on the reception side. When the message transmitted in broadcast is attached with a message authentication code or electronic signature, the message needs to be verified with a message authentication code or electronic signature within a predetermined period.

### SUMMARY OF THE INVENTION

In order to solve the above problem, a terminal apparatus according to an aspect of the present invention includes a reception unit configured to periodically receive a packet signal from a base station apparatus in each of two or more subframes in a superframe formed by time-multiplexing the subframes, an analysis unit configured to give a priority order to a subframe receiving the packet signal from the base station apparatus based on the packet signal received in the reception unit, and a processing unit configured to preferentially process the packet signal received in the subframe with a high priority order among the priority orders given in the analysis unit.

Another aspect of the present invention also provides a communication apparatus. The communication apparatus includes a generation unit configured to generate an electronic signature by a private key based on at least a security header and a payload, an encryption unit configured to perform an encryption processing on at least the payload and a security footer, and an output unit configured to output a security frame in which at least the security header, the payload and the security footer are arranged. The security header to be subjected to an electronic signature to be generated by the generation unit contains a public key certificate, and the private key corresponding to the public key certificate is used for generating the electronic signature, the encryption unit excludes the security header from the encryption processing, and the security footer contains the electronic signature generated in the generation unit, and the encryption processing is performed on the payload and the security footer in the security frame output from the output unit by the encryption unit.

Any combination of the constituents, and a modified representation of the present invention in a method, a apparatus, a system, a recording medium and a computer program are also effective as an aspect of the present invention.

### BRIEF DESCRIPTION OF THE DRAWINGS

FIG. 1 is a diagram illustrating a structure of a communication system according to an embodiment of the present invention;

FIGS. 2A to 2D are diagrams illustrating a format of a superframe defined in the communication system of FIG. 1;

FIGS. 3A and 3B are diagrams illustrating a structure of the subframes of FIGS. 2A to 2D;

FIGS. 4A to 4F are diagrams illustrating a format of a frame in each layer defined in the communication system of FIG. 1;

FIG. 5 is a diagram illustrating a data structure of a security frame of FIG. 4E;

FIG. 6 is a diagram illustrating a data structure of a message type of FIG. 5;

FIG. 7 is a diagram illustrating a data structure of a key ID of FIG. 5;

FIG. 8 is a diagram illustrating a data structure of a apparatus ID of FIG. 5;

FIG. 9 is a diagram illustrating a data structure of a public key certificate of FIG. 5;

FIG. 10 is a diagram illustrating a data structure of Nonce of FIG. 5;

FIG. 11 is a diagram illustrating a data structure of a data length of FIG. 5;

FIGS. 12A and 12B are diagrams illustrating a data structure of management data of FIG. 5;

FIG. 13 is a diagram illustrating a structure of a base station apparatus of FIG. 1;

FIGS. 14A to 14E are diagrams illustrating an outline of a signature generation processing performed in the base station apparatus of FIG. 13;

FIGS. 15A to 15D are diagrams illustrating an outline of an encryption processing performed in the base station apparatus of FIG. 13;

FIGS. 16A to 16D are diagrams illustrating a format of a security frame generated in the base station apparatus of FIG. 13;

FIG. 17 is a diagram illustrating a structure of a terminal apparatus mounted on a vehicle of FIG. 1;

FIGS. 18A to 18C are diagrams illustrating an outline of message authentication code generation performed in the terminal apparatus of FIG. 17;

FIGS. 19A to 19D are diagrams illustrating an outline of an encryption processing performed in the terminal apparatus of FIG. 17;

FIGS. 20A and 20B are diagrams illustrating a format of a security frame generated in the terminal apparatus of FIG. 17;

FIG. 21 is a diagram illustrating a structure of a terminal apparatus according to a modification of the present invention;

FIG. 22 is a diagram illustrating an outline of a reception processing by the terminal apparatus of FIG. 21;

FIG. 23 is a flowchart illustrating a procedure of the reception processing by the terminal apparatus of FIG. 21;

FIG. 24 is a diagram illustrating a structure of a terminal apparatus according to another modification of the present invention;

FIG. 25 is a diagram illustrating a data structure of a table stored in a priority order holding unit of FIG. 24;

FIG. 26 is a flowchart illustrating a procedure of a reception processing by the terminal apparatus of FIG. 24;

FIG. 27 is a diagram illustrating an outline of a reception processing by a terminal apparatus according to still another modification of the present invention;

FIG. 28 is a diagram illustrating an outline of the reception processing by the terminal apparatus according to still another modification of the present invention;

FIG. 29 is a diagram illustrating an exemplary data structure of a security frame according to a modification;

FIG. 30 is a flowchart illustrating a procedure of processing a packet signal in a priority order according to the modification;

FIG. 31 is a diagram (1) for explaining a priority order switch processing; and

FIG. 32 is a diagram (2) for explaining the priority order switch processing.

### DETAILED DESCRIPTION OF THE INVENTION

The invention will now be described by reference to the preferred embodiments. This does not intend to limit the scope of the present invention, but to exemplify the invention.

Before specifically describing the present invention, we will describe an outline thereof. An embodiment of the present invention relates to a communication system for making inter-vehicle communication between vehicle-mounted terminal apparatuses and for making road-to-vehicle communication from a base station apparatus installed at an intersection or the like to a terminal apparatus. For the inter-vehicle communication, the terminal apparatus transmits a packet signal storing vehicle information such as vehicle speed or position therein in broadcast (broadcast transmission of packet signals will be referred to as “broadcast” below). When receiving the packet signal, other terminal apparatus recognizes an approach of the vehicle based on the data. For the road-to-vehicle communication, the base station apparatus broadcasts a packet signal storing intersection information and traffic jam information therein. The information contained in the packet signals for the inter-vehicle communication and the road-to-vehicle communication will be collectively referred to as “data” for a simplified explanation.

The intersection information contains intersection circumstances such as a position of the intersection, shot images of the intersection installed with the base station apparatus, and position information of vehicles at the intersection. The terminal apparatus displays the intersection information on a monitor, recognizes the situation of the vehicles at the intersection based on the intersection information, and transmits the presence of other vehicles or pedestrians to a user in order to prevent head-on, right-turn and left-turn collisions, thereby preventing accidents. The traffic jam information contains information on congestion situations, roadworks or accidents of the roads around the intersection installed with the base station apparatus. The traffic jams in the travelling direction are transmitted or alternate routes are presented to the user based on the information.

For the communication, completeness, authenticity and confidentiality of the data are desired. Completeness is to ensure that information is not falsified, authenticity is to ensure data sources, and confidentiality is that the data is not known to the third parties. For example, a data authentication code using a common key encryption or an electronic signature using a public key encryption is added for completeness, an electronic signature (public key infrastructure (PKI)) is added to a public key certificate and data for authenticity, and data is encrypted for confidentiality. The processing amounts are different from each other, and should be applied as needed. Since the traffics in the inter-vehicle communication are more than the traffics in the road-to-vehicle communication, a data authentication code is attached and the data is encrypted for ensuring completeness and confidentiality of the data in the inter-vehicle communication. The data authentication code is used since it has a smaller amount of data and its verification processing is simpler than the electronic signature. In the road-to-vehicle communication, completeness, authenticity and confidentiality are ensured, and a public key certificate and an electronic signature are attached and the data is encrypted on the roadside apparatus. This is because a transmission data length has a more margin than in the inter-vehicle communication and important information such as traffic lights' information is contained in the data to be transmitted. Depending on a type of the data to be transmitted, the data may not be encrypted or a message authentication code or electronic signature may not be attached.

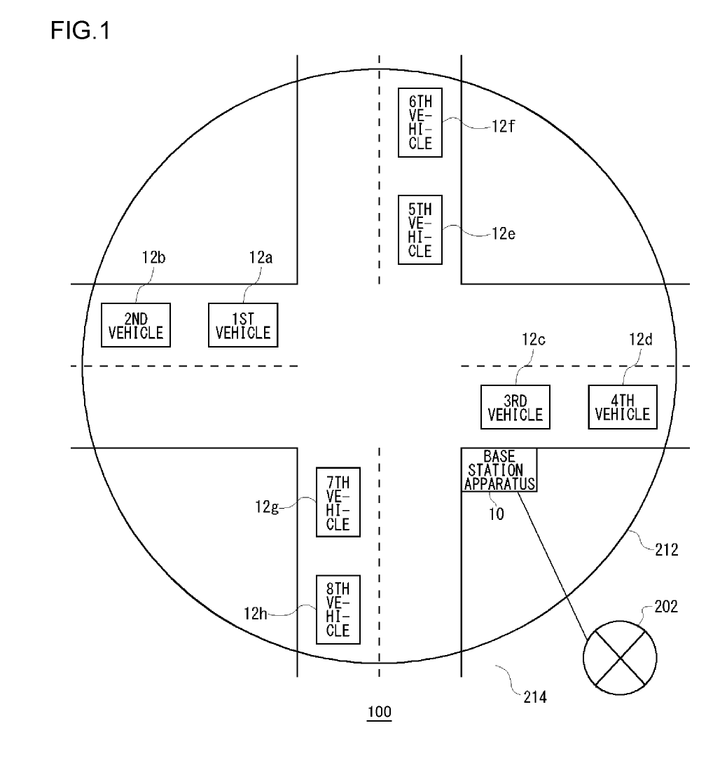

FIG. 1 illustrates a structure of a communication system 100 according to an embodiment of the present invention. This corresponds to a case in which one intersection is viewed from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, an eighth vehicle 12h which are collectively referred to as vehicle 12, and a network 202. Each vehicle 12 mounts a terminal apparatus (not shown) thereon.

As illustrated, a road in the horizontal direction of the figure or in the right and left direction and a road in the vertical direction of the figure or in the up and down direction intersect at the center. Herein, the upper side of the figure corresponds to “north”, the left side corresponds to “west”, the lower side corresponds to “south”, and the right side corresponds to “east.” The intersection part of the two roads is an “intersection.” The first vehicle 12a and the second vehicle 12b travel from left to right, and the third vehicle 12c and the fourth vehicle 12d travel from right to left. The fifth vehicle 12e and the sixth vehicle 12f travel from top to bottom, and the seventh vehicle 12g and the eighth vehicle 12h travel from bottom to top.

The communication system 100 arranges the base station apparatus 10 at the intersection. The base station apparatus 10 controls communication between the terminal apparatuses. The base station apparatus 10 repeatedly generates a superframe containing a plurality of subframes based on a signal received from the GPS satellite (not shown) or a superframe formed in other base station apparatus 10 (not shown). There is defined such that a road-to-vehicle transmission period can be set at the header of each subframe. The base station apparatus 10 selects a subframe for which the road-to-vehicle transmission period is not set by other base station apparatus 10 from among the subframes. The base station apparatus 10 sets the road-to-vehicle transmission period at the header of the selected subframe. The base station apparatus 10 broadcasts a packet signal in the set road-to-vehicle transmission period. This corresponds to the road-to-vehicle communication.

When receiving a packet signal from the base station apparatus 10, the terminal apparatus generates a superframe based on the information contained in the packet signal. Consequently, the superframes generated in the terminal apparatuses are synchronized with the superframe generated in the base station apparatus 10. When the terminal apparatus can receive a packet signal from the base station apparatus 10, the terminal apparatus can be present in an area 212. When being present in the area 212, the terminal apparatus broadcasts the packet signal in a carrier sense during a inter-vehicle transmission period. This corresponds to the inter-vehicle communication.

In the road-to-vehicle communication, an electronic signature generated with a private key of public key cryptosystem and a public key certificate on the roadside apparatus for verifying the electronic signature are attached. The electronic signature corresponds to a seal or signature on a sheet, and is mainly used for confirming the identity and preventing forgery and falsification. More specifically, when a person is described on a document as a creator of the document, that the document is truly created by the creator is proven by the signature or seal of the creator attached to the document in the case of a sheet document. However, a seal or signature cannot be directly attached to an electronic document, and thus an electronic signature is used for proving it. Hash function and public key encryption are used for generating an electronic signature.

A digital signature based on public key cryptosystem is dominant as an electronic signature. Specifically, a system based on public key cryptosystem employs RSA, DSA, ECDSA and the like. The electronic signature system includes a key generation algorithm, a signature algorithm and a verification algorithm. The key generation algorithm corresponds to a preparation of an electronic signature. The key generation algorithm outputs a user public key and private key. A different random number is selected whenever the key generation algorithm is executed, and a different pair of public key and private key is assigned per roadside apparatus. A public key certificate is formed to be attached with an electronic signature by a third party of the public key.

The roadside apparatus inputs its private key together with the data when creating an electronic signature by the signature algorithm. Only the roadside apparatus having its private key should know the private key used for the signature, and thus this is an evidence for identifying the transmission source of the data attached with the electronic signature. The user terminal apparatus receiving the data, the public key certificate and the electronic signature verifies the attached public key certificate on the roadside apparatus and confirms the validity of the roadside apparatus as an origination source by the previously-published authentication key for verifying the public key certificate of the roadside apparatus. When the validity is confirmed, the public key is taken out from the public key certificate of the roadside apparatus, and the electronic signature attached to the data is verified and its result is output. Processing loads of the verification processing in public key cryptosystem are typically heavy.

On the other hand, in the inter-vehicle communication, a packet signal attached with a message authentication code generated in common key cryptosystem is broadcasted. In common key cryptosystem, the same key is used between the terminal apparatus on the transmission side and the terminal apparatus on the reception side. The key used for verification is known and the key certificate is not required for the terminal apparatus on the reception side, and thus a deterioration in transmission efficiency is further restricted than in public key cryptosystem. When the same key is not present, the data authentication code cannot be confirmed and thus completeness of the data is ensured. Common key cryptosystem employs DES, AES, and the like. The data encryption employs common key cryptosystem in both the road-to-vehicle communication and the inter-vehicle communication.

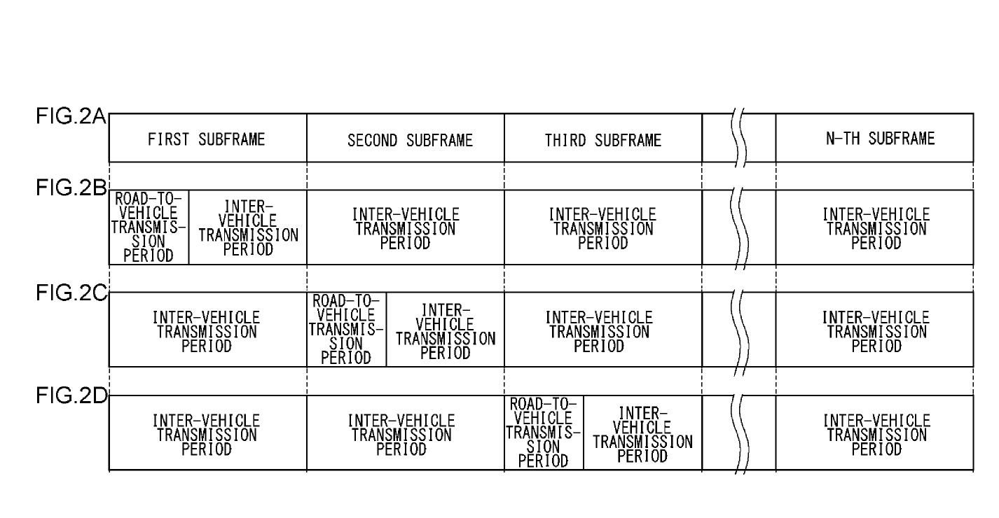

FIGS. 2A to 2D illustrate formats of superframes defined in the communication system 100. FIG. 2A illustrates a structure of a superframe. The superframe is formed of N subframes indicated as the first subframe to the N-th subframe. For example, when a length of the superframe is 100 msec and N is 8, a subframe having a length of 12.5 msec is defined. N may be any number other than 8. FIG. 2B illustrates a structure of a superframe generated by a first base station apparatus 10a. The first base station apparatus 10a corresponds to any one of the base station apparatuses 10. The first base station apparatus 10a sets a road-to-vehicle transmission period at the header of the first subframe. The first base station apparatus 10a sets the inter-vehicle transmission period subsequent to the road-to-vehicle transmission period in the first subframe. The inter-vehicle transmission period is a period in which the terminal apparatus can broadcast a packet signal. That is, there is defined such that the first base station apparatus 10a can broadcast a packet signal in the road-to-vehicle transmission period as a header period of the first subframe and the terminal apparatus can broadcast a packet signal in the inter-vehicle transmission period other than the road-to-vehicle transmission period in the frame. The first base station apparatus 10a sets only the inter-vehicle transmission period in the second subframe to the N-th subframe.

FIG. 2C illustrates a structure of a superframe generated by a second base station apparatus 10b. The second base station apparatus 10b corresponds to a base station apparatus 10 different from the first base station apparatus 10a. The second base station apparatus 10b sets the road-to-vehicle transmission period at the header of the second subframe. The second base station apparatus 10b sets the inter-vehicle transmission period after the road-to-vehicle transmission period in the second subframe, and in the first subframe, and the third subframe to the N-th subframe. FIG. 2D illustrates a structure of a superframe generated by a third base station apparatus 10c. The third base station apparatus 10c corresponds to a base station apparatus 10 different from the first base station apparatus 10a and the second base station apparatus 10b. The third base station apparatus 10c sets the road-to-vehicle transmission period at the header of the third subframe. The third base station apparatus 10c sets the inter-vehicle transmission period after the road-to-vehicle transmission period in the third subframe, and in the first subframe, the second subframe, and the fourth subframe to the N-th subframe. In this way, the base station apparatuses 10 select mutually-different subframes, and set the road-to-vehicle transmission period at the headers of the selected subframes, respectively.

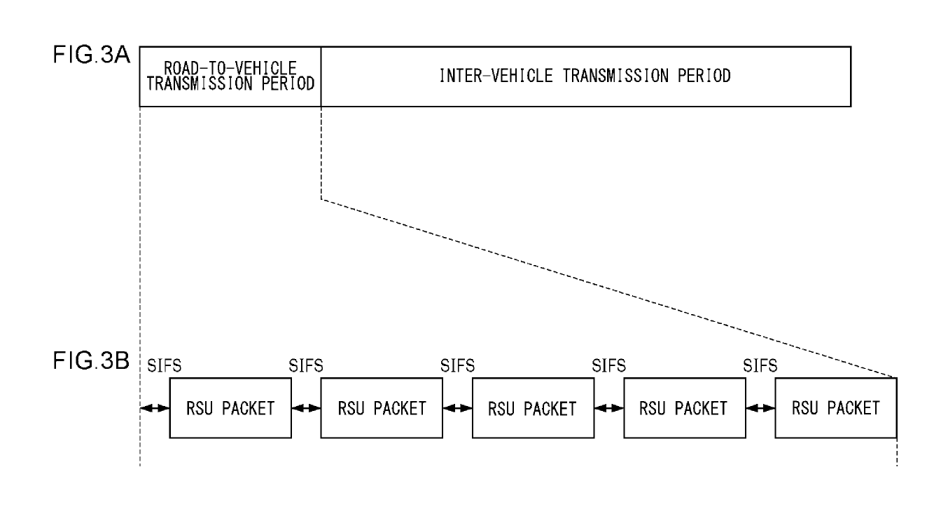

FIGS. 3A and 3B illustrate the structures of the subframes. As illustrated, one subframe is configured of the road-to-vehicle transmission period and the inter-vehicle transmission period in this order. The base station apparatus 10 broadcasts a packet signal in the road-to-vehicle transmission period, and the inter-vehicle transmission period has a predetermined length and the terminal apparatus can broadcast a packet signal in the period. FIG. 3B illustrates an arrangement of the packet signals in the road-to-vehicle transmission period. As illustrated, a plurality of RSU packet signals are arranged in the road-to-vehicle transmission period. The adjacent packet signals are away from each other by SIFS (Short Interframe Space).

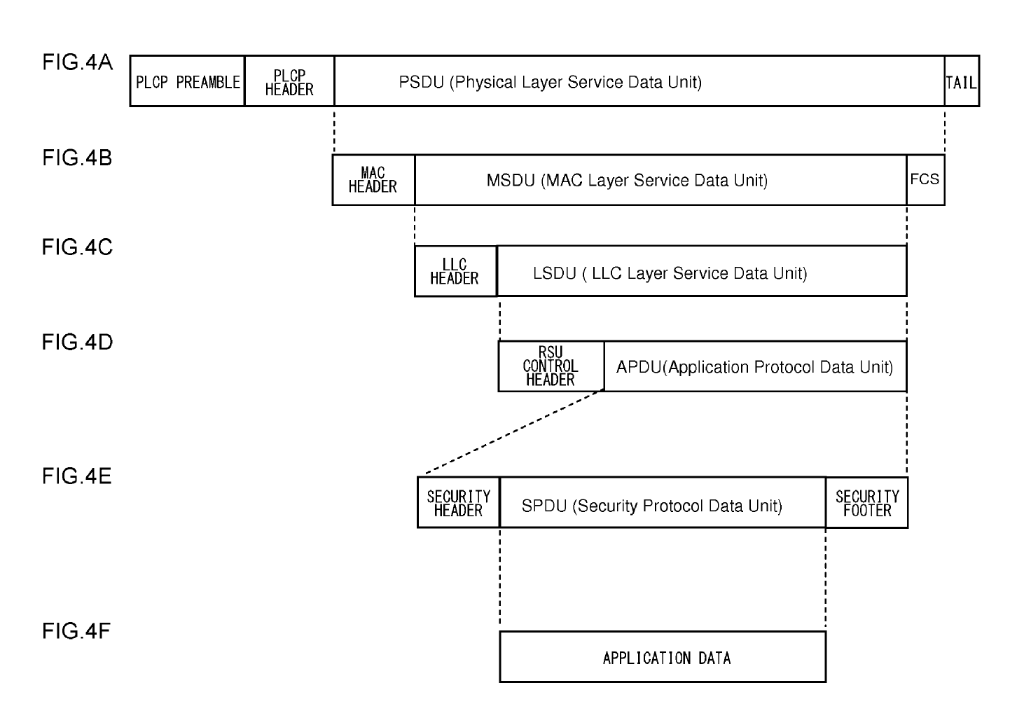

FIGS. 4A to 4F illustrate a format of a frame in each layer defined in the communication system 100, respectively. FIG. 4A illustrates a frame format in a physical layer. As illustrated, the frame arranges a PLCP preamble, a PLCP header, a PSDU (Physical Layer Service Data Unit), and a tail in this order therein. FIG. 4B illustrates a frame format in a MAC layer. The frame is stored in the PSDU of FIG. 4A. As illustrated, the frame arranges a MAC header, a MSDU (MAC Layer Service Data Unit), and a FCS in this order therein. FIG. 4C illustrates a frame format in a LLC layer. The frame is stored in the MSDU of FIG. 4B. As illustrated, the frame arranges a LLC header and a LSDU (LLC Layer Service Data Unit) in this order therein.

FIG. 4D illustrates a frame format in a inter-vehicle/road-to-vehicle common communication control information layer. The frame is stored in the LSDU of FIG. 4C. As illustrated, the frame arranges a RSU control header and an APDU (Application Protocol Data Unit) in this order therein. FIG. 4E illustrates a frame format in a security layer. The frame is stored in the APDU of FIG. 4D. As illustrated, the frame arranges a security header, a SPDU (Security Protocol Data Unit) and a security footer in this order therein. FIG. 4F illustrates a frame format in an application layer. The frame is stored in the SPDU of FIG. 4E and is configured of application data. The frames may be simply called “packet signal.”

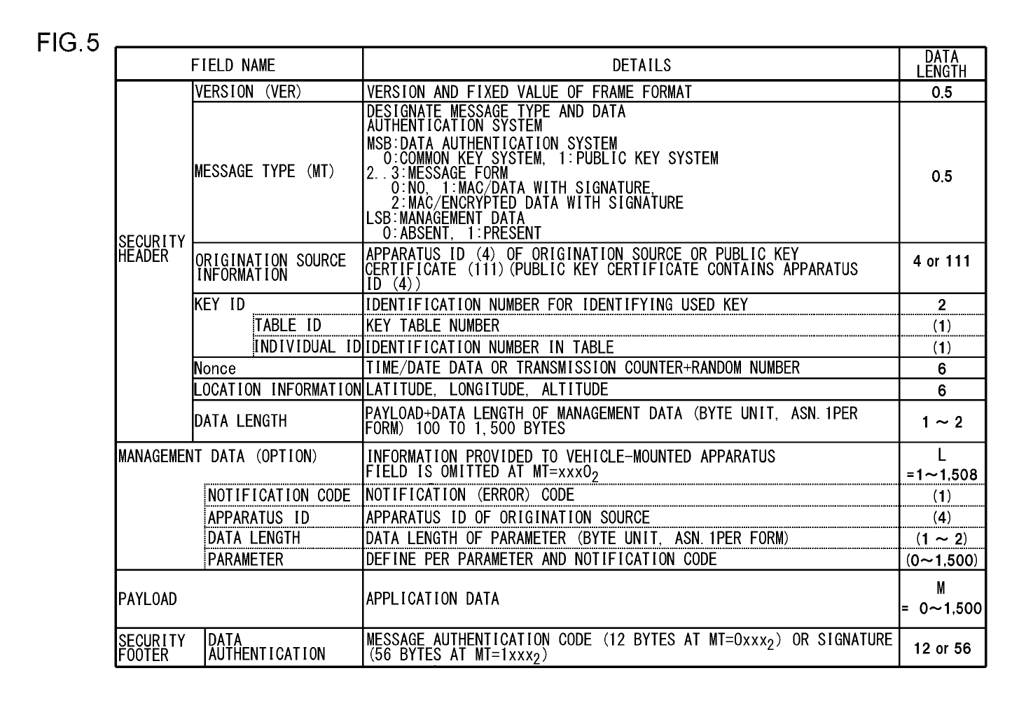

FIG. 5 illustrates a data structure of a security frame. This illustrates the contents of FIG. 4E in detail. The payload in the figure corresponds to the SPDU of FIG. 4E. The management data in the figure is optional and is not illustrated in FIG. 4E. The data lengths of the origination source information, the payload and the data authentication are variable. The origination source information is of 4 bytes of apparatus identification number (apparatus ID) when common key cryptosystem is used, and is of 111 bytes of public key certificate containing the apparatus ID of the origination source when public key cryptosystem is used. The data authentication is of 12 bytes of message authentication code in common key cryptosystem, and is of 56 bytes of electronic signature in public key cryptosystem. The message authentication code in common key cryptosystem is of AES 128 bits, and is of 12 bytes from the head of the final block (16 bytes) of the data encrypted with CBC mode. The electronic signature in public key cryptosystem is of 56 bytes found by the ECDAS using an oval curve code of 224 bits. SHA-224 is employed for the hash function.

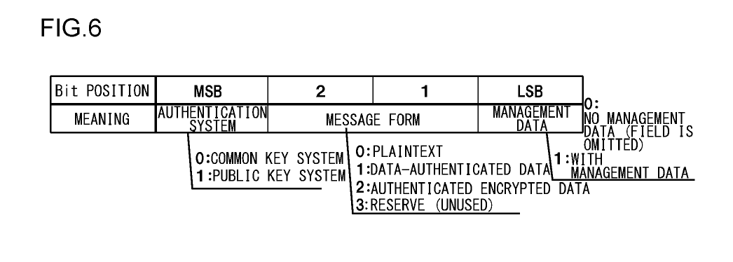

FIG. 6 illustrates a data structure of a message type. The message type is configured of 0.5 bytes. For the authentication system, common key cryptosystem is used in the inter-vehicle communication and public key cryptosystem is used in the road-to-vehicle communication. When the message form is data-authenticated data, an electronic signature or message authentication code is attached. When the message form is authenticated encrypted data, data encryption is performed in addition to the attachment of an electronic signature or message authentication code. When the message form is plaintext, an electronic signature or message authentication code is not attached and data encryption is not performed.

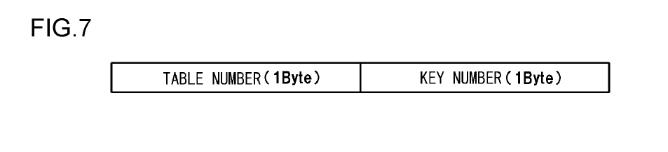

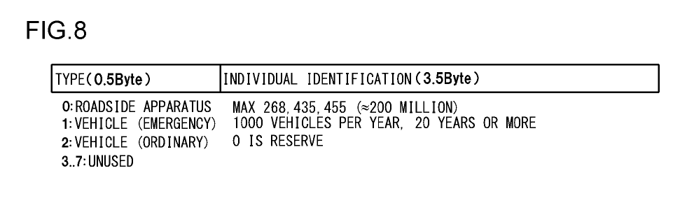

FIG. 7 illustrates a data structure of a key ID. The key ID is configured of 2 bytes. The table number indicates a common key table identification number, and the key number indicates an identification number in the common key table. The key number is randomly selected on origination. FIG. 8 illustrates a data structure of a apparatus ID. The apparatus ID is configured of 4 bytes, and is used for the message authentication code. The type indicates a type of a apparatus and a type of a vehicle mounting the apparatus. An individual type indicates an identification number for identifying each apparatus.

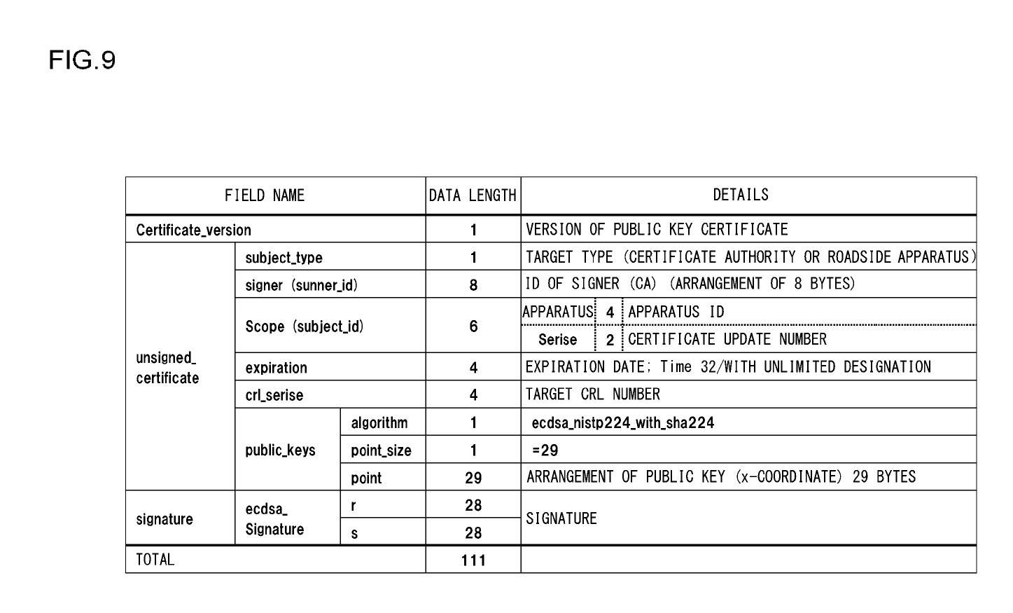

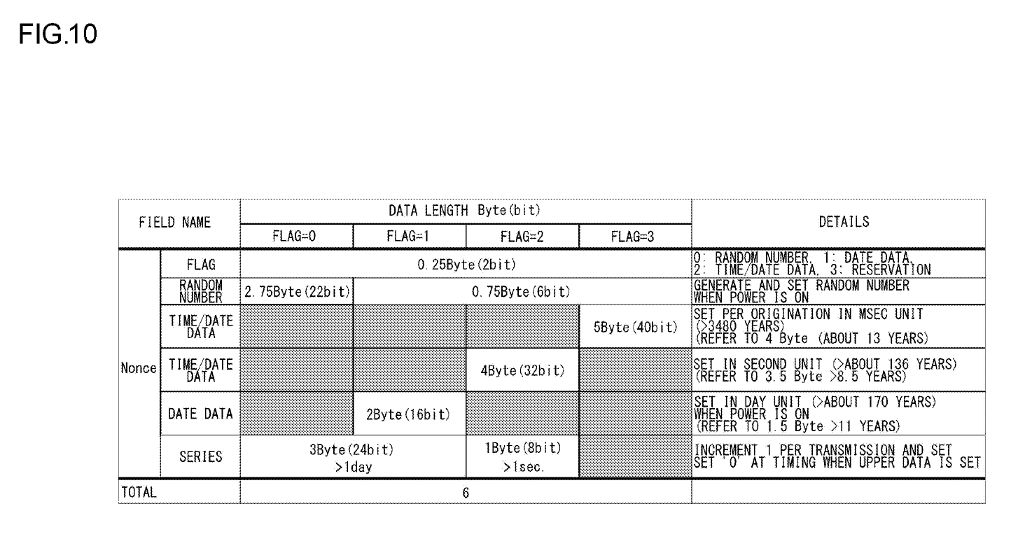

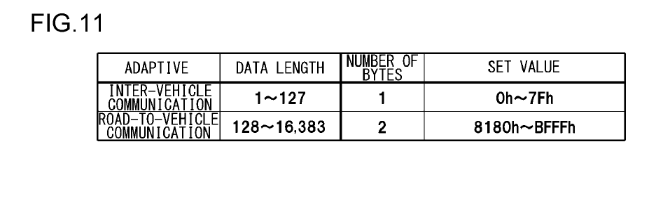

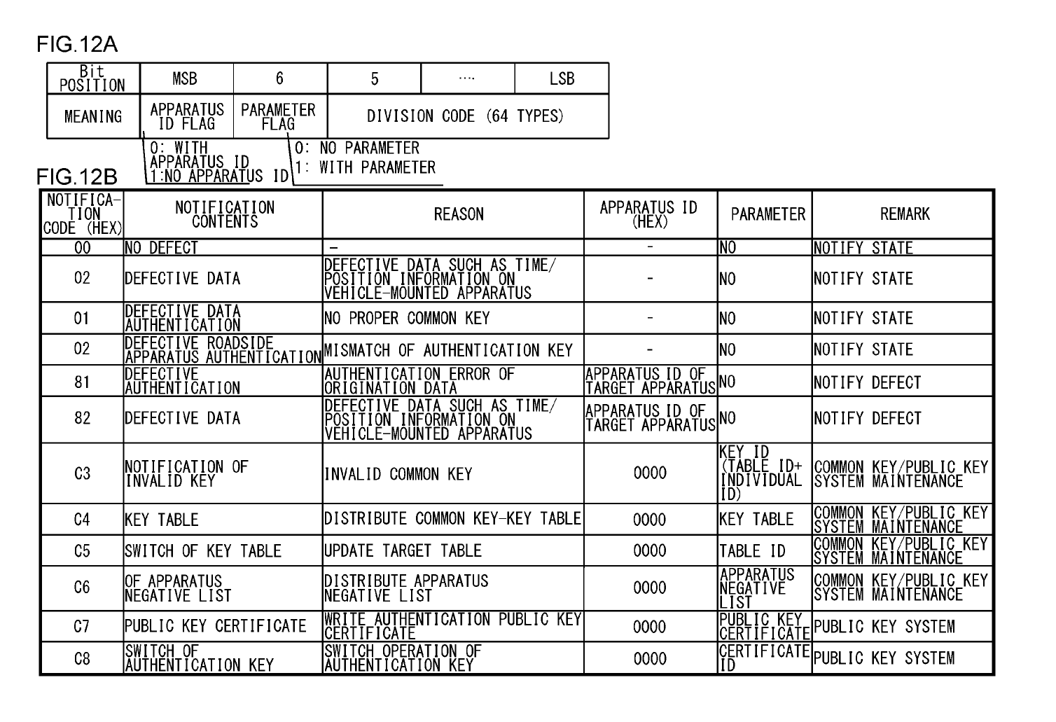

FIG. 9 illustrates a data structure of a public key certificate. The public key certificate contains the apparatus ID of FIG. 8. The public key certificate is used for the electronic signature. FIG. 10 illustrates a data structure of Nonce. The Nonce is configured of 6 bytes. The Nonce is selected and set depending on the presence and accuracy of a clock function. FIG. 11 illustrates a data structure of a data length. The data length is configured of 1 byte to 2 bytes. As illustrated, different data lengths are defined in the inter-vehicle communication and the road-to-vehicle communication. FIGS. 12 A and 12B illustrate a data structure of management data. FIG. 12A illustrates a data structure of a notification code. FIG. 12B illustrates notification contents of the notification code.

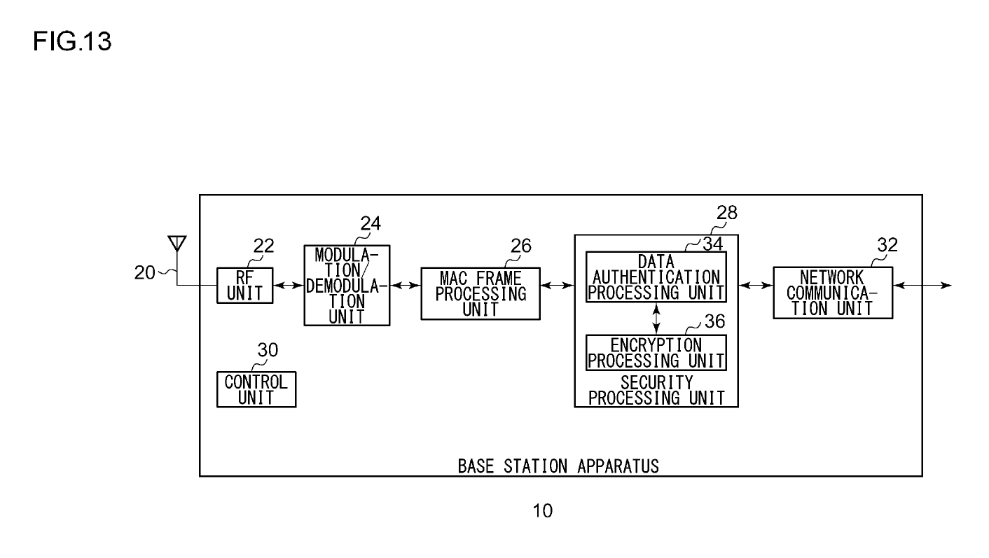

FIG. 13 illustrates a structure of the base station apparatus 10. The base station apparatus 10 includes an antenna 20, a RF unit 22, a modulation/demodulation unit 24, a MAC frame processing unit 26, a security processing unit 28, a control unit 30 and a network communication unit 32. The security processing unit 28 includes a data authentication processing unit 34 and an encryption processing unit 36.

The RF unit 22 receives a packet signal from a terminal apparatus (not shown) or other base station apparatus 10 by the antenna 20 for the reception processing. The RF unit 22 performs frequency conversion on the received wireless frequency packet signal, and generates a baseband packet signal. The RF unit 22 further outputs the baseband packet signal to the modulation/demodulation unit 24. Typically, the baseband packet signal is formed of an in-phase component and an orthogonal component and thus should be indicated by two signal lines, but only one signal line is indicated herein for clarifying the figure. The RF unit 22 includes a LNA (Low Noise Amplifier), a mixer, an AGC and an A/D conversion unit.

The RF unit 22 performs frequency conversion on the baseband packet signal input from the modulation/demodulation unit 24 and generates a wireless frequency packet signal for the transmission processing. The RF unit 22 further transmits the wireless frequency packet signal from the antenna 20 in the road-to-vehicle transmission period. The RF unit 22 includes a PA (Power amplifier), a mixer, and a D/A conversion unit.

The modulation/demodulation unit 24 demodulates the baseband packet signal from the RF unit 22 for the reception processing. The modulation/demodulation unit 24 further outputs a MAC frame to the MAC frame processing unit 26 based on the demodulation result. The modulation/demodulation unit 24 modulates the MAC frame from the MAC frame processing unit 26 for the transmission processing. The modulation/demodulation unit 24 further outputs the modulation result as a baseband packet signal to the RF unit 22. Herein, the communication system 100 copes with the OFDM (Orthogonal Frequency Division Multiplexing) modulation system, and thus the modulation/demodulation unit 24 also performs FFT (Fast Fourier Transform) for the reception processing and performs IFFT (Inverse Fast Fourier Transform) for the transmission processing.

The MAC frame processing unit 26 extracts a security frame from the MAC frame from the modulation/demodulation unit 24 for the reception processing, and outputs it to the security processing unit 28. The MAC frame processing unit 26 adds a MAC header, a LLC header and a RSU control header to the security frame from the security processing unit 28 for the transmission processing, and generates and outputs a MAC frame to the modulation/demodulation unit 24. Timing control is performed for preventing the packet signals from other base station apparatus or terminal apparatus from crashing.

The data authentication processing unit 34 receives application data from the network communication unit 32 for the transmission processing. This corresponds to the application data of FIG. 4F. The data authentication processing unit 34 stores the application data in the payload. The data authentication processing unit 34 generates the security header illustrated in FIG. 5 to FIG. 10. At this time, the public key certificate illustrated in FIG. 9 is attached and corresponds to originator authentication. When the message authentication illustrated in FIG. 6 is of data-authenticated data or authenticated encrypted data, the data authentication processing unit 34 generates an electronic signature for the security header and the payload.

Thus, the security header as a target of the electronic signature contains a public key certificate, and the private key corresponding to the public key certificate is used for generating the electronic signature. The data authentication processing unit 34 stores the electronic signature in the security footer. When the management data is contained, the data authentication processing unit 34 generates an electronic signature by the private keybased on the security header, the management data and the payload. On the other hand, when the message authentication illustrated in FIG. 6 is plaintext, the data authentication processing unit 34 does not generate an electronic signature. At this time, the data authentication processing unit 34 stores dummy data in the security footer.

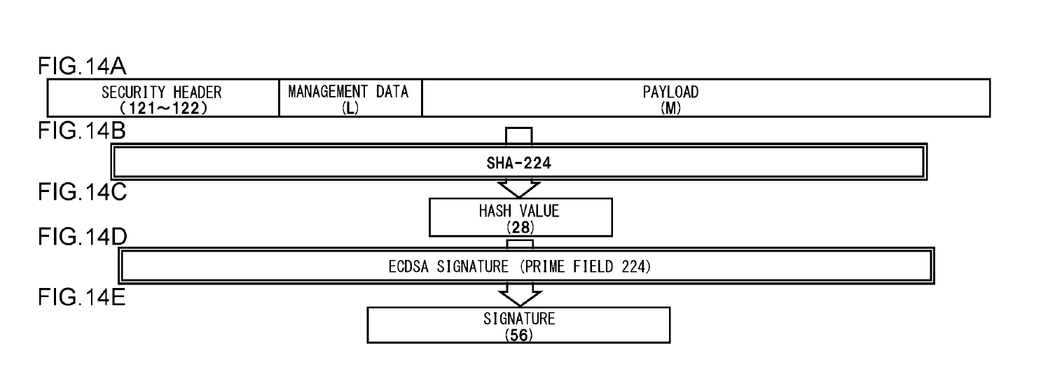

FIGS. 14A to 14E illustrate an outline of a signature generation processing performed in the base station apparatus 10. FIG. 14A illustrates the security header, the management data and the payload to be processed in the data authentication processing unit 34. FIG. 14B illustrates a SHA-224 calculation made on the security header, the management data and the payload in the data authentication processing unit 34. SHA-224 (Secure Hash Algorithm) is a group of associated hash functions. FIG. 14C illustrates a hash value as a result of the SHA-224. The hash value has a fixed length of 28 bytes. FIG. 14D illustrates a ECDSA signature calculation made on the hash value in the data authentication processing unit 34. FIG. 14E illustrates an electronic signature as a calculation result of the ECDSA signature. The electronic signature has a fixed length of 56 bytes. Return to FIG. 13.

When the message authentication illustrated in FIG. 6 is of authenticated encrypted data, the encryption processing unit 36 receives the payload and the security footer from the data authentication processing unit 34. As described above, the security footer contains the electronic signature generated in the data authentication processing unit 34. The encryption processing unit 36 performs the encryption processing on the payload and the security footer. The encryption employs AES128-CTR, for example. When the management data is contained, the encryption processing unit 36 performs the encryption processing on the management data, the payload and the security footer. The encryption processing unit 36 excludes the security header from the encryption processing.

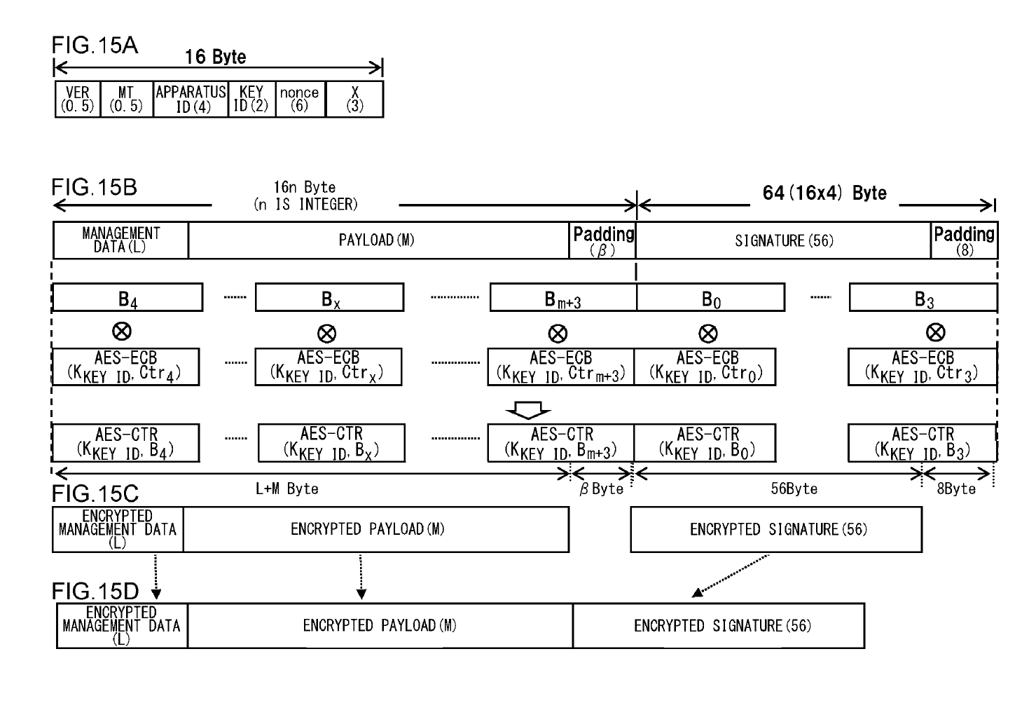

FIGS. 15A to 15D illustrate an outline of the encryption processing performed in the base station apparatus 10. FIG. 15A illustrates a structure of the encryption key used for the encryption in the encryption processing unit 36. As illustrated, the encryption key has a fixed length of 16 bytes. FIG. 15B illustrates a calculation for the encryption processing in the encryption processing unit 36. As illustrated, the encryption is performed in units of 16 bytes by the encryption key. More specifically, the encryption processing unit 36 inserts padding such that the size of the management data and the payload is an integral multiple of 16 bytes, and inserts padding of 8 bytes such that the size of the signature is an integral multiple of 16 bytes. FIG. 15C illustrates an encryption result. As illustrated, the encrypted management data, the encrypted payload and the encrypted signature are generated. FIG. 15D illustrates an output from the encryption processing unit 36. As illustrated, the encrypted management data, the encrypted payload and the encrypted signature are integrally output. Return to FIG. 13.

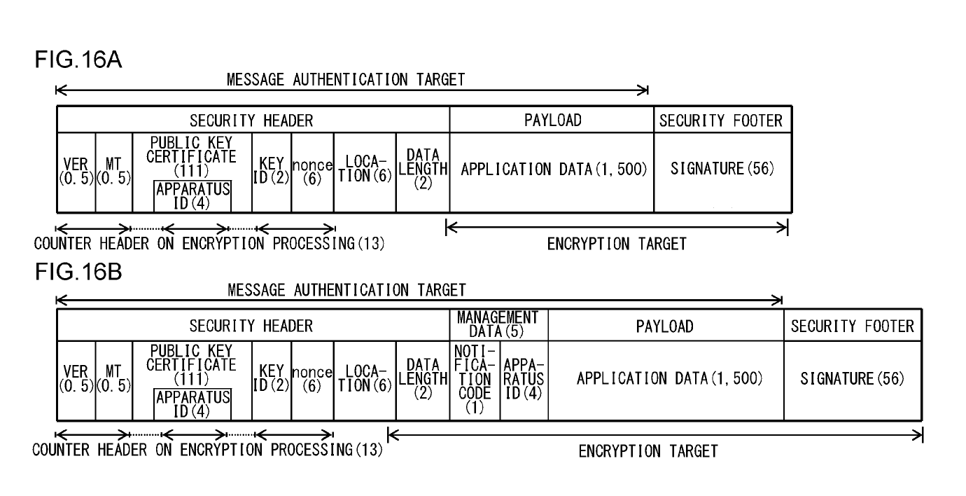

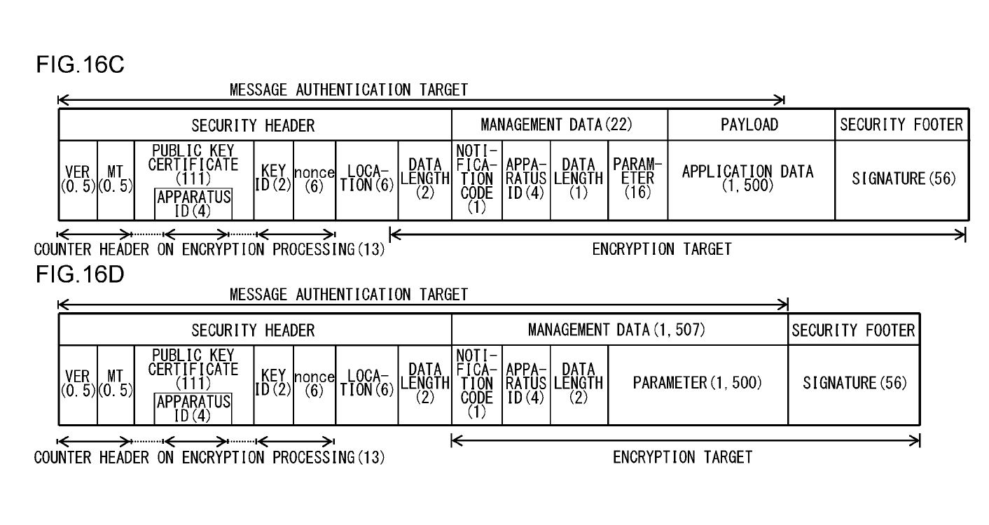

As illustrated in FIG. 4E and FIG. 5, the security processing unit 28 outputs a security frame in which at least the security header, the payload and the security footer are arranged. The management data may be contained. When the message authentication is of authenticated encrypted data, the payload and the security footer in the security frame are encrypted. When the management data is contained, the management data is also encrypted. FIGS. 16A to 16D illustrate formats of security frames generated in the base station apparatus 10. FIG. 16A illustrates a case in which the management data is not contained. FIG. 16B illustrates a case in which only the notification code and the apparatus ID in the management data are contained. FIG. 16C illustrates a case in which a parameter is contained in the management data. FIG. 16D illustrates a case in which only the management data is contained and the payload is not contained. As illustrated, whether the message form is data-authenticated data, authenticated encrypted data or plaintext, the format of the security frame is common. Return to FIG. 13. The security processing unit 28 outputs the security frame to the MAC frame processing unit 26.

The security processing unit 28 receives the security frame from the MAC frame processing unit 26 for the reception processing. The security processing unit 28 confirms the contents of the security header in the security frame. When the message form is data-authenticated data, the data authentication processing unit 34 performs a message verification processing. When the message form is authenticated encrypted data, the data authentication processing unit 34 performs the message verification processing and the encryption processing unit 36 performs a decryption processing. When the message form is plaintext, the processings are omitted. When the transmission source of the security frame is other base station apparatus 10, the data authentication processing unit 34 and the encryption processing unit 36 perform the message verification processing and the decryption processing corresponding to the electronic signature generation processing and the encryption processing, respectively. The data authentication processing unit 34 performs apparatus authentication based on the public key certificate contained in the security frame. On the other hand, when the transmission source of the security frame is the terminal apparatus, the data authentication processing unit 34 and the encryption processing unit 36 perform the message verification processing and the decryption processing corresponding to the electronic signature generation processing and the encryption processing performed in the terminal apparatus, respectively. The electronic signature generation processing and the encryption processing performed in the terminal apparatus will be described later. The security processing unit 28 outputs a processing result to the network communication unit 32.

The network communication unit 32 is connected to a network (not shown). The network communication unit 32 outputs the processing results in the security processing unit 28 to a network (not shown) and accumulates them therein, and periodically outputs them to a network (not shown). The network communication unit 32 receives road information (such as roadworks and traffic jams) from a network (not shown). The control unit 30 controls the entire processings of the base station apparatus 10.

The structure can be realized by a CPU, a memory or other LSI in any computer in hardware, and can be realized by a program loaded in a memory in software, and the functional blocks realized in their association are depicted. Thus, those skilled in the art can understand that the functional blocks can be realized in any form such as hardware only, software only, or a combination thereof.

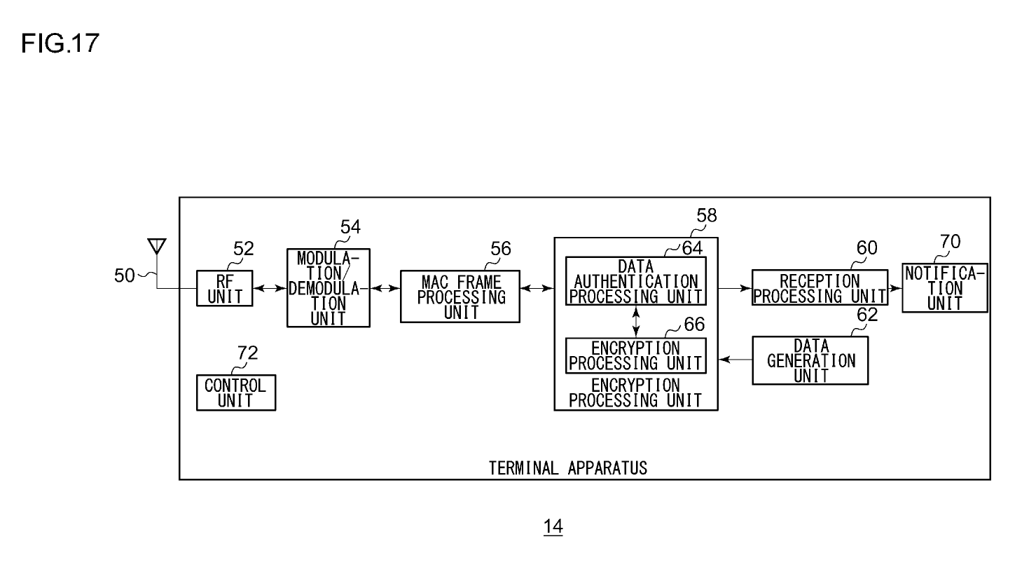

FIG. 17 illustrates a structure of the terminal apparatus 14 mounted on the vehicle 12. The terminal apparatus 14 includes an antenna 50, a RF unit 52, a modulation/demodulation unit 54, a MAC frame processing unit 56, a security processing unit 58, a reception processing unit 60, a data generation unit 62, a notification unit 70 and a control unit 72. The security processing unit 58 includes a data authentication processing unit 64 and an encryption processing unit 66. The antenna 50, the RF unit 52, the modulation/demodulation unit 54 and the MAC frame processing unit 56 perform the same processings as the antenna 20, the RF unit 22, the modulation/demodulation unit 24 and the MAC frame processing unit 26 in FIG. 13. Thus, the explanation of the same processings will be omitted and differences will be mainly described.

The data authentication processing unit 64 receives application data from the data generation unit 62 for the transmission processing. This corresponds to the application data of FIG. 4F. The data authentication processing unit 64 stores the application data in the payload. The data authentication processing unit 64 generates the security header illustrated in FIG. 5 to FIG. 10. When the message authentication illustrated in FIG. 6 is of data-authenticated data or authenticated encrypted data, the data authentication processing unit 64 generates a message authentication code by the common key based on the security header and the payload.

The data authentication processing unit 64 stores the message authentication code in the security footer. When the management data is contained, the data authentication processing unit 64 generates a message authentication code by the common key based on the security header, the management data and the payload. On the other hand, when the message authentication illustrated in FIG. 6 is of plaintext, the data authentication processing unit 64 does not generate a message authentication code. At this time, the data authentication processing unit 64 stores dummy data in the security footer.

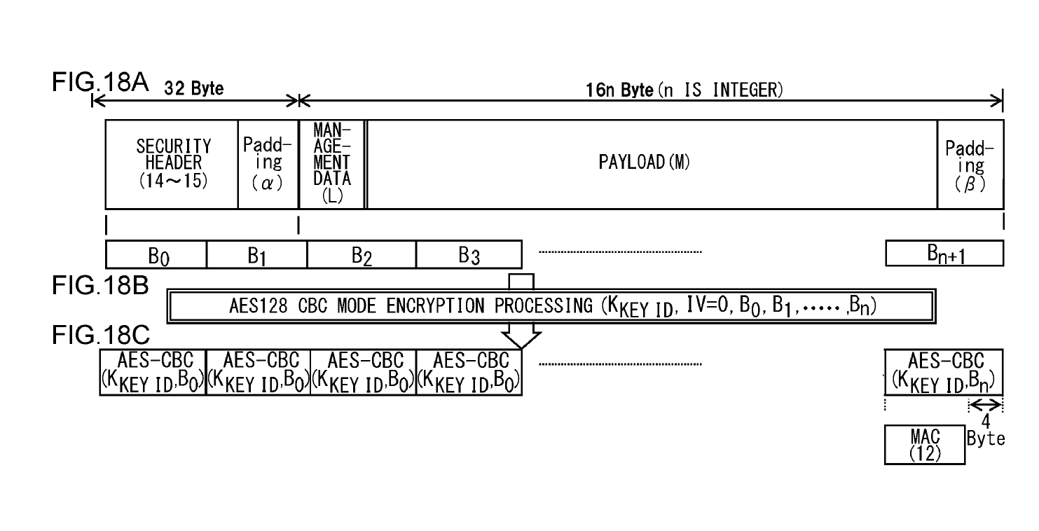

FIGS. 18A to 18C illustrate an outline of the message authentication code generation performed in the terminal apparatus 14. FIG. 18A illustrates the security header, the management data and the payload to be processed by the data authentication processing unit 64. The data authentication processing unit 64 inserts padding such that the size of the security header is 32 bytes, and inserts padding such that the size of the management data and the payload is an integral multiple of 16 bytes. FIG. 18B illustrates a calculation of an AES128-CBC mode encryption processing performed on the padding-inserted security header, management data and payload in the data authentication processing unit 64. FIG. 18C illustrates an encryption result and a message authentication code generated based on the encryption result. The message authentication code has a fixed length of 12 bytes. Return to FIG. 17.

When the message authentication illustrated in FIG. 6 is of authenticated encrypted data, the encryption processing unit 66 receives the payload and the security footer from the data authentication processing unit 64. As described above, the security footer contains the message authentication code generated in the data authentication processing unit 64. The encryption processing unit 66 performs the encryption processing on the payload and the security footer. The encryption employs AES-CTR, for example. When the management data is contained, the encryption processing unit 66 performs the encryption processing on the management data, the payload and the security footer. The encryption processing unit 66 excludes the security header from the encryption processing.

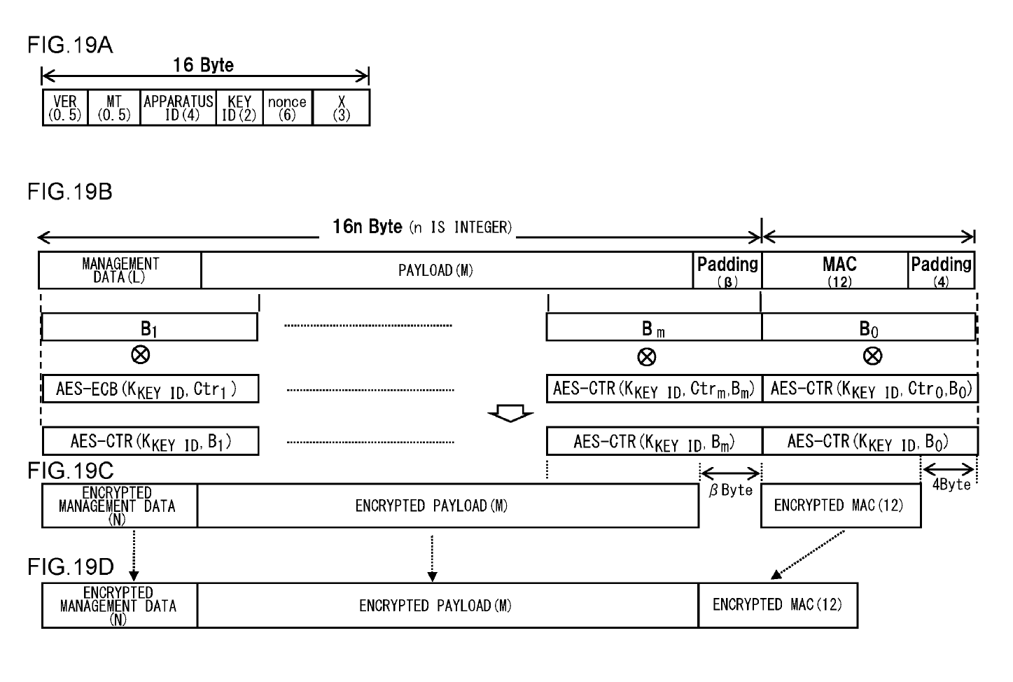

FIGS. 19A to 19D illustrate an outline of the encryption processing performed in the terminal apparatus 14. FIG. 19A illustrates a structure of an encryption key used for the encryption in the encryption processing unit 66. As illustrated, the encryption key has a fixed length of 16 bytes. FIG. 19B illustrates a calculation for the encryption processing in the encryption processing unit 66. As illustrated, the encryption is performed in units of 16 bytes by the encryption key. More specifically, the encryption processing unit 66 inserts padding such that the size of the management data and the payload is an integral multiple of 16 bytes, and inserts padding of 4 bytes such that the size of the message authentication code is an integral multiple of 16 bytes. FIG. 19C illustrates an encryption result. As illustrated, the encrypted management data, the encrypted payload and the encrypted message authentication code are generated. FIG. 19D illustrates an output from the encryption processing unit 66. As illustrated, the encrypted management data, the encrypted payload and the encrypted message authentication code are integrally output. Return to FIG. 17.

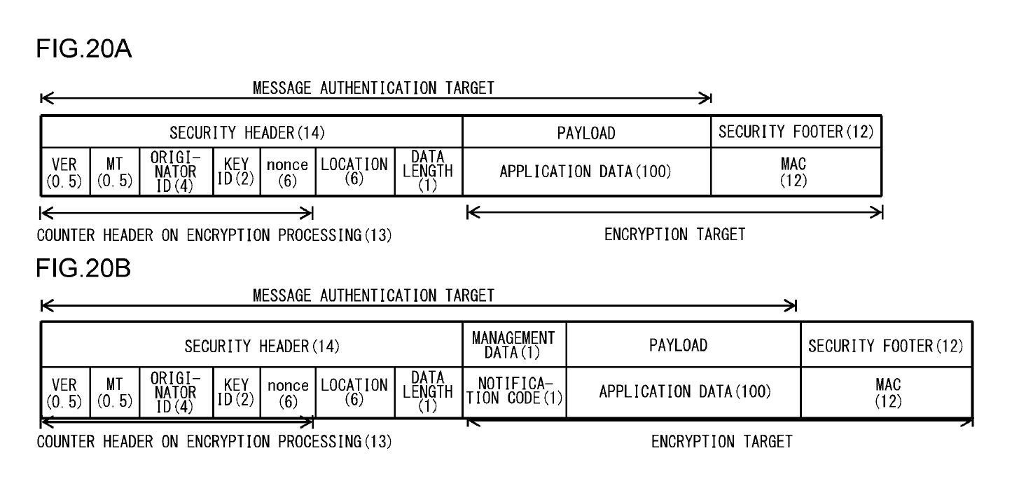

The security processing unit 58 outputs the security frame in which at least the security header, the payload and the security footer are arranged as illustrated in FIG. 4E and FIG. 5. The management data may be contained. When the message authentication is of authenticated encrypted data, the payload and the security footer in the security frame are encrypted. When the management data is contained, the management data is also encrypted. FIGS. 20A and 20B illustrate formats of security frames generated in the terminal apparatus 14. FIG. 16A illustrates a case in which the management data is not contained. FIG. 16B illustrates a case in which the management data is contained. Return to FIG. 17. The security processing unit 58 outputs the security frame to the MAC frame processing unit 56.

The security processing unit 58 receives the security frame from the MAC frame processing unit 26 for the reception processing. The security processing unit 58 confirms contents of the security header in the security frame. When the message form is data-authenticated data, the data authentication processing unit 64 performs the message verification processing. When the message form is authenticated encrypted data, the data authentication processing unit 64 performs the message verification processing and the encryption processing unit 66 performs the decryption processing. When the message form is plaintext, the processings are omitted. When the transmission source of the security frame is other terminal apparatus 14, the data authentication processing unit 64 and the encryption processing unit 66 perform the message verification processing and the decryption processing corresponding to the electronic signature generation processing and the encryption processing, respectively. On the other hand, when the transmission source of the security frame is the base station apparatus 10, the data authentication processing unit 64 and the encryption processing unit 66 perform the message verification processing and the decryption processing corresponding to the electronic signature generation processing and the encryption processing performed in the base station apparatus 10 previously described. The security processing unit 58 outputs a processing result to the reception processing unit 60.

The reception processing unit 60 estimates a risk of collision, an approach of emergency vehicle such as ambulance or firetruck, a congestion situation of the road in the travelling direction and the intersection based on the data received from the security processing unit 58 and the vehicle information received from the data generation unit 62. The data, if any image information, is processed to be displayed on the notification unit 70. The notification unit 70 includes a notification means to the user such as monitor, lamp or speaker (not shown). An approach of other vehicle 12 (not shown) is notified to the driver via the monitor, lamp or speaker in response to an instruction from the reception processing unit 60. The traffic jam information or the intersection image information is displayed on the monitor.

The data generation unit 62 includes a GPS receiver (not shown), a gyroscope, a vehicle speed sensor and the like, and acquires the vehicle information (not shown), that is, a presence position, a travelling direction, a moving speed, and the like of the vehicle 12 mounting the terminal apparatus 14 thereon based on the information supplied therefrom. The presence position is indicated by latitude and longitude. The acquisition may employ a well-known technique, and its explanation will be omitted herein. The data generation unit 62 generates data based on the acquired information, and outputs the generated data as application data to the security processing unit 58. The control unit 72 controls the entire operations of the terminal apparatus 14.

A modification of the present invention will be described below. The modification of the present invention relates to a communication system in which the inter-vehicle communication and the road-to-vehicle communication are made similarly as in the embodiment. The terminal apparatus receives a plurality of packet signals from the base station apparatus during the road-to-vehicle transmission period. When the number of packet signals is 7 and an electronic signature is attached, the terminal apparatus performs an originator authentication processing once and a message authentication processing seven times. The originator authentication processing is performed on only the first packet signal. Consequently, the terminal apparatus performs the ECDSA verification processing eight times and the SHA calculation seven times in the road-to-vehicle transmission period. Assuming that a superframe contains a plurality of subframes and the number of subframes is 16, the terminal apparatus is requested to perform the ECDSA verification processing 128 times for the superframe. As described above, a length of the superframe is 100 msec, and thus the ECDSA verification processing is required to terminate in a shorter period than 1 msec. Typically, the processing amount of the ECDSA verification processing is large, and thus a high-speed calculator capable of completing the processing in a shorter period than 1 msec is difficult to mount on the terminal apparatus. That is, when the packets by all the road-to-vehicle communication are to be verified, cost for the terminal apparatus remarkably increases and wide use thereof is prevented.

In order to address the same, the base station apparatus according to the modification broadcasts the position information on the base station apparatus contained in a packet signal. For example, the position information on the base station apparatus is contained in the security header. When receiving a plurality of packet signals from the base station apparatus in predetermined periods, the terminal apparatus extracts the position information from each packet signal. The terminal apparatus compares the position information extracted from each packet signal with its position information, thereby to derive a distance between the base station apparatus broadcasting each packet signal and the terminal apparatus. The terminal apparatus gives a priority order to each of the subframes such that a base station apparatus with a shorter distance has a higher priority order. The terminal apparatus preferentially receives a packet signal from a subframe with a higher priority order in the road-to-vehicle transmission period. In the subframe not capable of being processed in the superframe, the terminal apparatus does not receive a packet signal in the road-to-vehicle transmission period. The communication system 100 according to the modification of the present invention is of the same type as FIG. 1, and the base station apparatus 10 according to the modification of the present invention is of the same type as FIG. 13. Differences will be mainly described herein.

The security processing unit 28 in the base station apparatus 10 contains the position information in the security header. The position information is indicated by latitude and longitude, and may be indicated by altitude. The information on the upper part of latitude and longitude may be omitted in order to reduce the information amount of the position information.

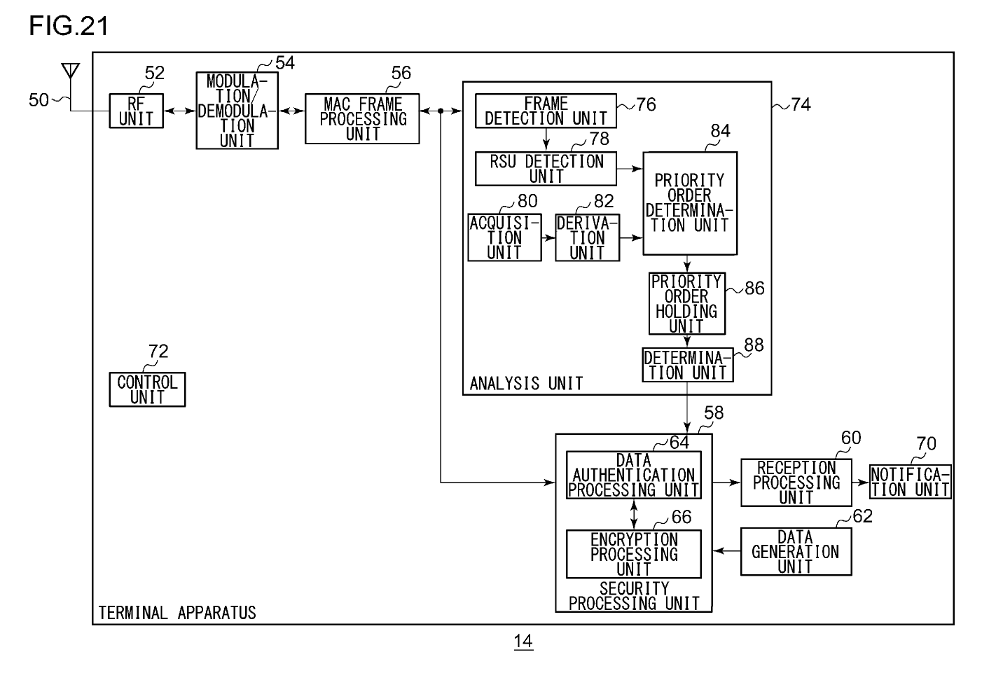

FIG. 21 illustrates a structure of the terminal apparatus 14 according to the modification of the present invention. The terminal apparatus 14 includes the antenna 50, the RF unit 52, the modulation/demodulation unit 54, the MAC frame processing unit 56, the security processing unit 58, the reception processing unit 60, the data generation unit 62, the notification unit 70, the control unit 72, and an analysis unit 74. The security processing unit 58 includes the data authentication processing unit 64 and the encryption processing unit 66, and the analysis unit 74 includes a frame detection unit 76, a RSU detection unit 78, an acquisition unit 80, a derivation unit 82, a priority order determination unit 84, a priority order holding unit 86 and a determination unit 88. The transmission processing by the terminal apparatus 14 is the same as in the terminal apparatus 14 of FIG. 17.

The frame detection unit 76 acquires the received packet signals and the packet signals from the base station apparatuses 10 via the MAC frame processing unit 56. The packet signals are periodically received in the road-to-vehicle transmission period in each of two or more subframes in a superframe. As described above, the packet signal contains the position information on the base station apparatus 10 as a transmission source. When acquiring the packet signal, the frame detection unit 76 confirms the detection of the superframe. Consequently, a timing synchronization with the superframe and timing synchronizations with the respective subframes contained in the superframe are established.

The RSU detection unit 78 specifies a subframe which receives the packet signal from the base station apparatus 10 among the subframes contained in the superframe detected in the frame detection unit 76. This corresponds to the detection of a subframe for which the road-to-vehicle transmission period is set among the subframes. The RSU detection unit 78 outputs the information on the subframe for which the road-to-vehicle transmission period is set to the priority order determination unit 84. In the information on the subframe for which the road-to-vehicle transmission period is set, the subframe is associated with the base station apparatus 10 which sets the road-to-vehicle transmission period in the subframe.

The acquisition unit 80 acquires the position information on the base station apparatus 10 contained in the security header in the received packet signal. When receiving the packet signals from the base station apparatus 10, the acquisition unit 80 acquires the position information on each base station apparatus 10. The acquisition unit 80 also acquires the position information on the terminal apparatus 14. The position information on the terminal apparatus 14 is supplied from the data generation unit 62. The acquisition unit 80 outputs the position information on the terminal apparatus 14 and the position information on each base station apparatus 10 to the derivation unit 82.

The derivation unit 82 receives the position information on the terminal apparatus 14 and the position information on each base station apparatus 10 from the acquisition unit 80. The derivation unit 82 derives a distance from each base station apparatus 10 based on the position information on the terminal apparatus 14 and the position information on each base station apparatus 10. A vector calculation is made, for example, in order to derive the distance. The derivation unit 82 outputs the distance from each base station apparatus 10 to the priority order determination unit 84.

The priority order determination unit 84 receives the information on the subframe for which the road-to-vehicle transmission period is set from the RSU detection unit 78 and receives the distance from each base station apparatus 10 from the derivation unit 82. The priority order determination unit 84 gives a priority order to each base station apparatus 10 such that as the derived distance is shorter, the priority order is higher. The priority order determination unit 84 specifies a subframe for which each base station apparatus 10 sets the road-to-vehicle transmission period based on the information on the subframe for which the road-to-vehicle transmission period is set, thereby to give a priority order to each subframe. A priority order may not be given to a subframe for which the road-to-vehicle transmission period is not set, or the lowest priority order may be given thereto. The priority order determination unit 84 outputs a priority order given to each subframe to the priority order holding unit 86.

The priority order holding unit 86 receives the priority order given to each subframe from the priority order determination unit 84, and stores information on the priority order. The determination unit 88 causes the security processing unit 58 to preferentially process the packet signal received by the subframe given with a higher priority order among the priority orders given to the respective subframes. For example, when the packet signals in the road-to-vehicle transmission period set in two subframes can be processed by the processing capability of the terminal apparatus 14, the determination unit 88 selects two subframes in descending order of the priority order. The security processing unit 58 performs the reception processing on the packet signal in the road-to-vehicle transmission period of the subframe designated by the determination unit 88. The security processing unit 58 stops the reception processing in the road-to-vehicle transmission period in other subframe.

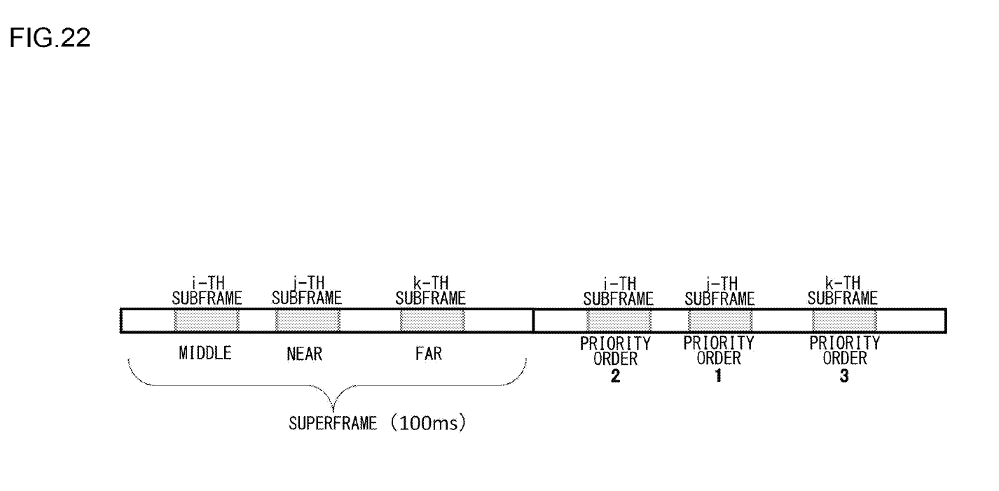

FIG. 22 illustrates an outline of the reception processing by the terminal apparatus 14. The horizontal axis in the figure indicates time. It is herein assumed that a distance from the base station apparatus 10 broadcasting a packet signal in the road-to-vehicle transmission period in the i-th subframe in one superframe is “middle.” Further, it is assumed that a distance from the base station apparatus 10 broadcasting a packet signal in the road-to-vehicle transmission period in the j-th subframe is “near” and a distance from the base station apparatus 10 broadcasting a packet signal in the road-to-vehicle transmission period in the k-th subframe is “far”. Thus, the terminal apparatus 14 gives a priority order “2” to the i-th subframe, gives a priority order “1” to the j-th subframe, and gives a priority “3” to the k-th subframe. When the number of subframes capable of processing a packet signal in the road-to-vehicle transmission period is “2”, the terminal apparatus 14 determines to receive in the i-th subframe and the j-th subframe.

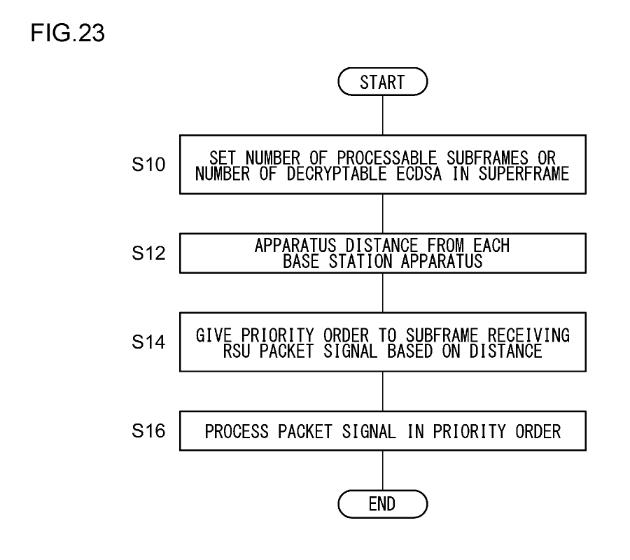

The operations of the communication system 100 with the above structure will be described. FIG. 23 is a flowchart illustrating a procedure of the reception processing by the terminal apparatus 14. The determination unit 88 sets the number of processable subframes or the number of decryptable ECDSA in a superframe (S10). The derivation unit 82 derives a distance from each base station apparatus 10 (S12). The priority order determination unit 84 gives a priority order to a subframe receiving a RSU packet signal based on the distance (S14). The security processing unit 58 processes the packet signal in the priority order (S16). The priority order is assumed to be determined based on the distance between the base station apparatus and the terminal apparatus, but the terminal apparatus mounted on the vehicle moves and thus the moving direction of the terminal apparatus is considered for determining the priority order. That is, the travelling direction of the vehicle mounting the terminal apparatus thereon is considered as a determination reference, and the priority order may be set to be higher for the near distance in the travelling direction.

Another modification of the present invention will be described below. Another modification of the present invention relates to a communication system in which the inter-vehicle communication and the road-to-vehicle communication are made as described above. In the modification, the base station apparatus broadcasts the position information contained in the packet signal in order to restrict the number of ECDSA verification processings according to a length of the superframe. The terminal apparatus sets a priority order to be higher for the subframe for which the base station apparatus with a near distance sets the road-to-vehicle transmission period, and preferentially performs the ECDSA verification processing on the subframe in descending order of the priority order. Another modification also has an object to restrict the number of ECDSA verification processings according to a length of the superframe. However, the base station apparatus according to another modification does not contain the position information in the packet signal.

On the other hand, when receiving the packet signals from the base station apparatus, the terminal apparatus measures reception power of each packet signal. The terminal apparatus gives a priority order to each of the subframes such that a higher priority order is given to the base station apparatus as a transmission source of the packet signal with higher reception power. The terminal apparatus preferentially receives a packet signal in a subframe with a higher priority order in the road-to-vehicle transmission period. The communication system 100 according to another modification of the present invention is of the same type as FIG. 1, and the base station apparatus 10 according to another modification of the present invention is of the same type as FIG. 13. Differences will be mainly described herein.

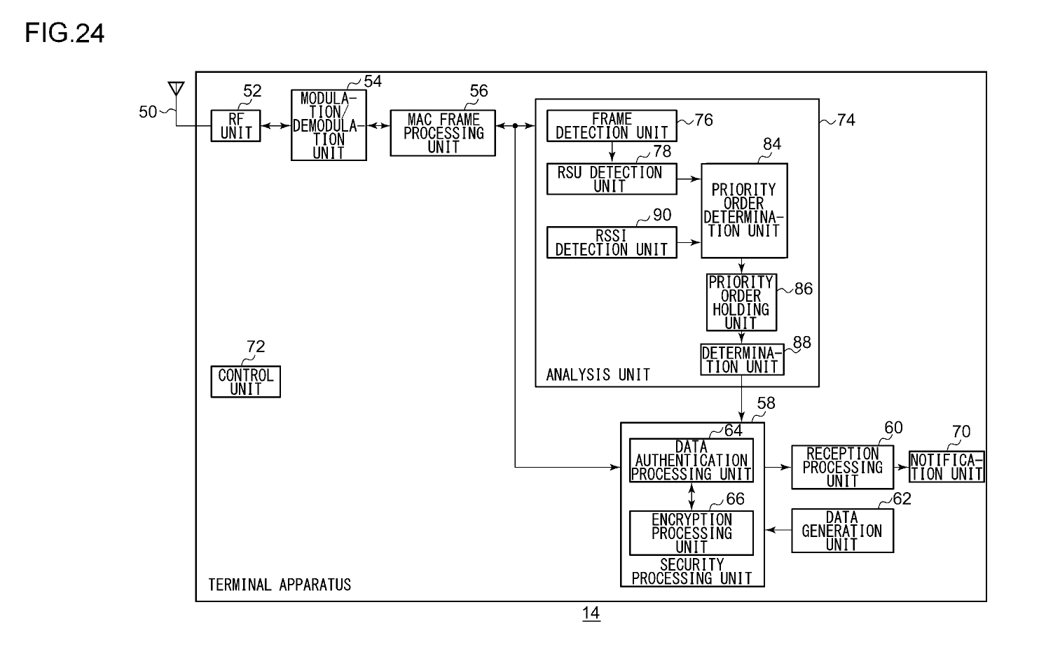

FIG. 24 illustrates a structure of the terminal apparatus 14 according to another modification of the present invention. The terminal apparatus 14 includes a RSSI detection unit 90 instead of the acquisition unit 80 and the derivation unit 82 in the terminal apparatus 14 illustrated in FIG. 21. The RSSI detection unit 90 detects RSSI of a packet signal received in the road-to-vehicle transmission period set in a subframe. This corresponds to measurement of reception power of the packet signal. A plurality of packet signals are received in one road-to-vehicle transmission period, but the RSSI detection unit 90 calculates their average and assumes the average value as RSSI in the subframes. The RSSI detection unit 90 outputs RSSI in each subframe to the priority order determination unit 84.

The priority order determination unit 84 receives the information on the subframe for which the road-to-vehicle transmission period is set from the RSU detection unit 78, and receives the RSSI of each subframe from the RSSI detection unit 90. The priority order determination unit 84 gives a priority order to each subframe such that as the RSSI is higher, the priority order is higher. This corresponds to giving a priority order to each base station apparatus 10. The priority order determination unit 84 outputs the priority order given to each subframe to the priority order holding unit 86.

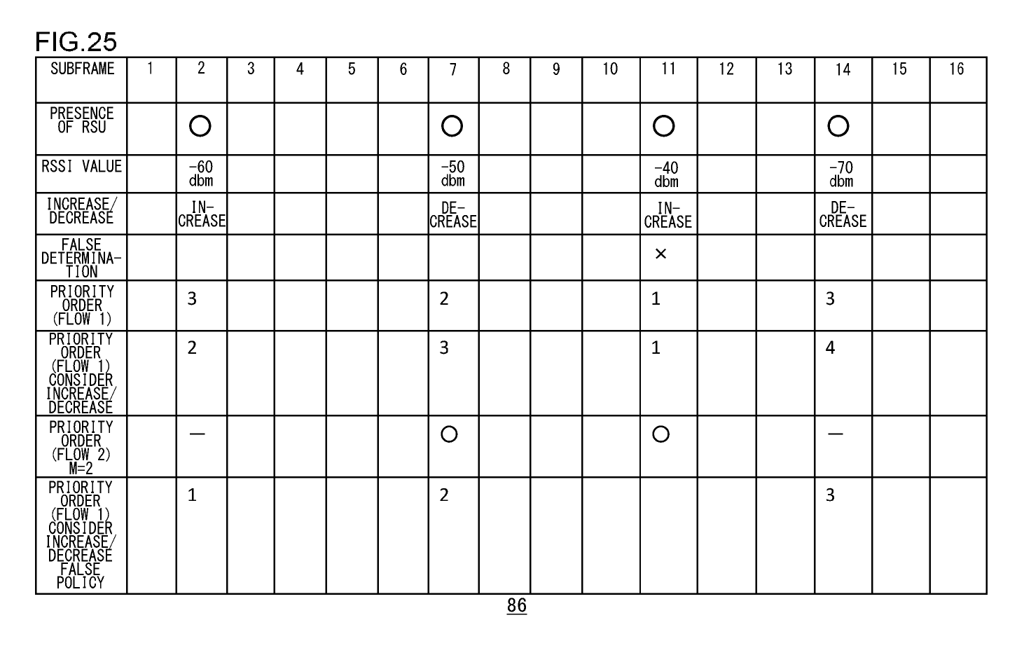

FIG. 25 illustrates a data structure of a table stored in the priority order holding unit 86. It is herein assumed that 16 subframes are arranged in a superframe. “Presence of RSU” corresponds to that the road-to-vehicle transmission period is set. “Priority order (flow 1)” is a priority order determined by the priority order determination unit 84 as described above. The priority order determination unit 84 may monitor a temporal change in RSSI and may set a priority order based on the temporal change. For example, as the RSSI increases, a higher priority order may be given. This corresponds to “consider increase/decrease in priority order (flow 1).” “Priority order 2 (flow) M=2” and “priority order (flow 1) increase/decrease false policy” will be described below.

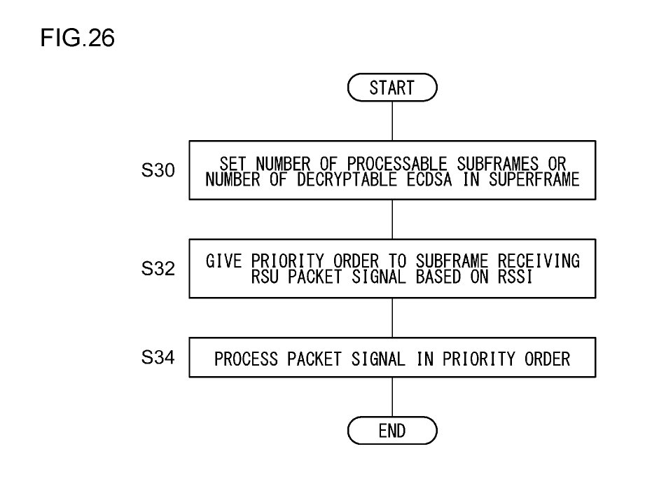

The operations of the communication system 100 with the above structure will be described. FIG. 26 is a flowchart illustrating a procedure of the reception processing by the terminal apparatus 14. The determination unit 88 sets the number of processable subframes or the number of decryptable ECDSA in a superframe (S30). The priority order determination unit 84 gives a priority order to the subframe receiving the RSU packet signal based on the RSSI (S32). The security processing unit 58 processes the packet signal in the priority order (S34). The priority order may be given based on a combination of RSSI increase/decrease and distance.

Still another modification of the present invention will be described below. Still another modification of the present invention relates to a communication system in which the inter-vehicle communication and the road-to-vehicle communication are made as described above. In another modification, a priority order is given to each of the subframes based on reception power in order to restrict the number of times of the ECDSA verification processing according to a length of the superframe. Still another modification corresponds to the processing subsequent thereto. The terminal apparatus preferentially processes the packet signal in the road-to-vehicle transmission period in the subframe with a higher priority order. Message authentication is performed by the electronic signature contained in the packet signal, but may not be verified.

When verification fails, the terminal apparatus excludes the processing in the road-to-vehicle transmission period in the subframe from the next superframe. This corresponds to discarding the priority order of the subframe and advancing a lower priority order. The communication system 100 according to still another modification of the present invention is of the same type as FIG. 1, the base station apparatus 10 according to still another modification of the present invention is of the same type as FIG. 13, and the terminal apparatus 14 according to still another modification of the present invention is of the same type as FIG. 24. Differences will be mainly described herein.

The data authentication processing unit 64 performs the verification processing on the electronic signature contained in the security footer for the reception processing as described above, and when the verification result is invalid, notifies the fact to the analysis unit 74. When receiving the fact that the verification result is invalid, the priority order determination unit 84 refers to the priority order holding unit 86 to discard the priority order of the corresponding subframe. The priority order determination unit 84 refers to the priority order holding unit 86 to correct the priority order such that a lower priority order than the discarded priority order is advanced. The priority order holding unit 86 stores the corrected priority orders. This corresponds to “priority order (flow 1) increase/decrease false policy” in FIG. 25. The security processing unit 58 processes the packet signal corresponding to the new priority order. That is, the security processing unit 58 excludes the processing on the subframe for which the verification result is invalid from the next superframe.

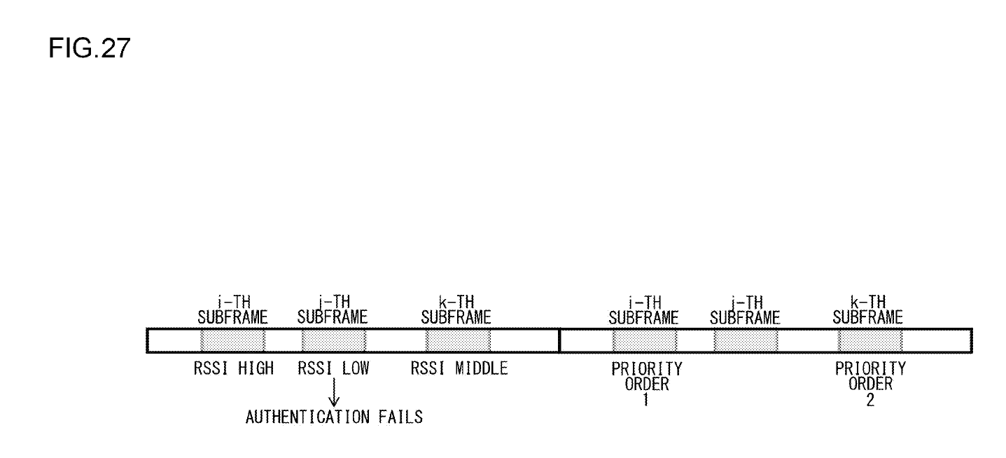

FIG. 27 illustrates an outline of a reception processing by the terminal apparatus 14 according to still another modification of the present invention. It is herein assumed that RSSI of a packet signal received in the road-to-vehicle transmission period in the i-th subframe is “middle” in a superframe. It is assumed that RSSI of a packet signal received in the road-to-vehicle transmission period in the j-th subframe is “high” and RSSI of a packet signal received in the road-to-vehicle transmission period in the k-th subframe is “low.” Thus, the terminal apparatus 14 gives a priority order “2” to the i-th subframe, gives a priority order “1” to the j-th subframe, and gives a priority order “3” to the k-th subframe. However, the authentication of the j-th subframe fails, a priority order “1” is given to the i-th subframe and a priority order “2” is given to the k-th subframe.

Still another modification of the present invention will be described below. Still another modification of the present invention relates to a communication system in which the inter-vehicle communication and the road-to-vehicle communication are made as described above. In another modification, a priority order is given to each of the subframes based on reception power in order to restrict the number of ECDSA verification processings according to a length of the superframe. The priority order is similarly given also in still another modification, but the priority order is given to a different target from other embodiment. In still another embodiment, a superframe is divided into a plurality of zones. For example, a superframe is divided into two zones such as the former zone and the latter zone. At this time, an integral number of subframes are contained in each zone.

The terminal apparatus gives the priority orders to the subframes contained in the former zone (which will be referred to as “first zone” below), and gives the priority orders to the subframes contained in the latter zone (which will be referred to as “second zone” below). Herein, the priority orders in the first zone and the priority orders in the second zone are independent from each other. The processing reduces a possibility of calculating ECDSA in the consecutive subframes. The communication system 100 according to still another modification of the present invention is of the same type as FIG. 1, the base station apparatus 10 according to still another modification of the present invention is of the same type as FIG. 13, and the terminal apparatus 14 according to still another modification of the present invention is of the same type as FIG. 24. Differences will be mainly described herein.

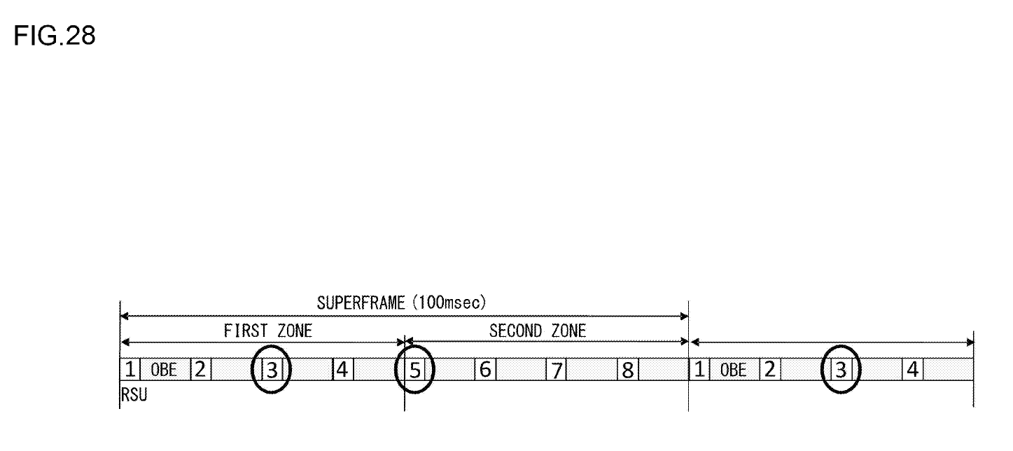

The priority order determination unit 84 gives the priority orders to the subframes contained in the first zone in the superframe, and independently gives the priority orders to different subframes contained in the second zone. FIG. 28 illustrates an outline of the reception processing by the terminal apparatus 14 according to still another modification of the present invention. It is herein assumed that one superframe is formed of eight subframes for clarifying the description. The terminal apparatus 14 gives the highest priority order to the third subframe in the first zone, and gives the highest priority order to the fifth subframe in the second zone.

Still another modification of the present invention will be described below. Still another modification of the present invention relates to a communication system in which the inter-vehicle communication and the road-to-vehicle communication are made as described above. The communication system 100 according to the modification is of the same type as FIG. 1, the base station apparatus 10 is of the same type as FIG. 13, and the terminal apparatus 14 is of the same type as FIG. 21. In the modification, the priority order determination unit 84 gives the priority orders to the subframes, and then the determination unit 88 adjusts a thinning rate of the electronic signature verification according to the priority orders. The determination unit 88 sets the thinning rate of the electronic signature verification of the RSU packet signals to be lower as the subframe has a higher priority order, and sets the thinning rate of the electronic signature verification of the RSU packet signals to be higher as the subframe has a lower priority order. In the subframe with the highest priority order, the thinning of the electronic signature verification of the RSU packet signals does not need to be performed. The security processing unit 58 sets a verification timing per subframe from the base station apparatus 10 at the thinning rate according to the priority order given per subframe from the base station apparatus 10 in the analysis unit 74, and performs the verification processing on the electronic signature contained in the packet signal received in the subframe from the base station apparatus 10 at the verification timing. The security processing unit 58 performs the verification processing on the public key certificate, and performs either one of the public key certificate verification processing and the electronic signature verification processing at the verification timing.

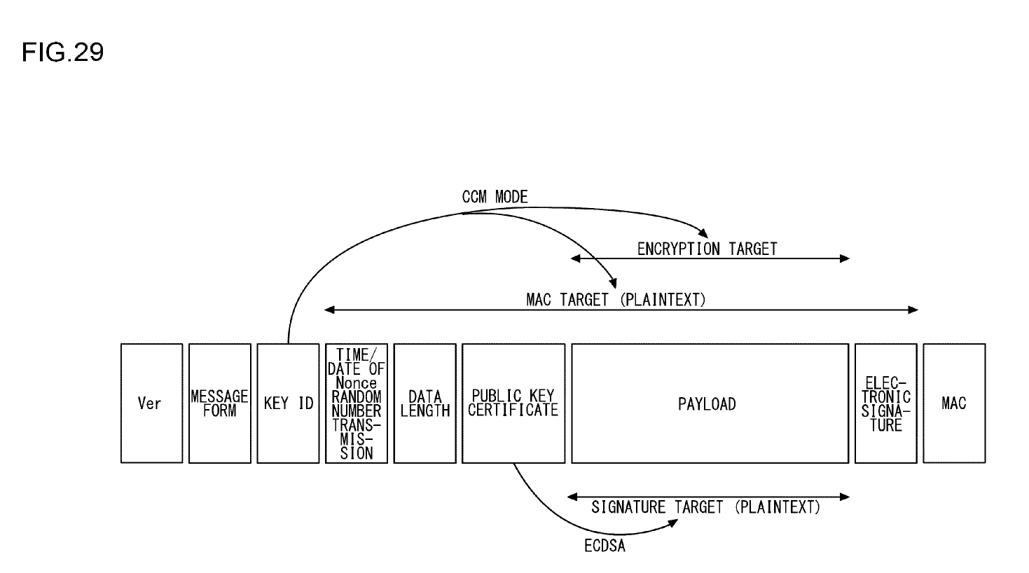

FIG. 29 is a diagram illustrating an exemplary data structure of a security frame according to the modification. With the data structure, “version”, “message form”, “key ID”, “nonse”, “data length” and “public key certificate” are arranged for the security header, and then “payload” is arranged, and finally “electronic signature” and “MAC” are arranged for the security footer. In the example, “payload” is to be subjected to signature, “nonse”, “data length”, “public key certificate”, “payload” and “electronic signature” are to be subjected to MAC generation, and “payload”, “electronic signature” and “MAC” are to be encrypted. Thus, the electronic signature is generated, MAC is generated, and then encryption is performed.

“Version” indicates a version of a frame format. “Message form” designates a message form. The message form includes a plaintext data form, an authenticated data form, and an authenticated encrypted data form. When the message form is a plaintext data form and an authenticated data form, the above encryption is not performed. In the case of a plaintext data form, the electronic signature and the MAC are not generated. Thus, the data known to “electronic signature” and “MAC”, for example, all the items of data are set at 0. “Key ID” is information for identifying a communication key shared between the base station apparatus 10 and the terminal apparatus 14. When the data form is an authenticated data form and an authenticated encrypted data form, the communication key identified by “apparatus ID” is used to perform MAC generation or encryption. The communication key can employ a common key in the previously-shared common key in common key cryptosystem, such as AES (Advanced Encryption Standard) key.

“Nonse” is set with a unique value per communication used for disturbing the result in the MAC generation and the encryption using the communication key. The value may be a random number or a transmission time. Further, the apparatus ID of the origination source may be added to the random number or transmission time. “Data length” sets a data length of an encryption target (more specifically, the number of bytes). When the data length of “public key certificate” is a fixed length, the data length of “payload” may be set.

“Public key certificate” sets a public key certificate for the public key unique to the base station apparatus 10. The public key certificate is a certificate associating the public key and an owner of the public key. The public key certificate includes signer identification information, apparatus ID, expiration date, public key (containing key generation algorithm and size), signer's signature, and the like. In the modification, the signer is assumed as certificate authority (CA). The signature is generated in public key cryptosystem such as RSA, DSA (Digital Signature Algorithm) or ECDSA (Elliptic Curve-DSA). The modification employs ECDSA.

“Electronic signature” is set with a signature for “payload.” The signature is generated by the private key paired with the public key contained in “public key certificate.”

For “MAC”, MAC generated by applying a predetermined MAC algorithm to the common key and the MAC target is set. The common key is a communication key shared between the base station apparatus 10 and the terminal apparatus 14. In the example of FIG. 29, “MAC” substitutes a CBC-MAC value using the communication key of AES specified by “key ID.” Authenticated and encrypted data is generated using CCM (Counter with CBC-MAC) mode. “MAC” is a simpler authentication method than “electronic signature”, and has a smaller amount of data and is capable of high-speed processing. The data authentication processing unit 34 in the base station apparatus 10 generates both “electronic signature” and “MAC.”

The procedure of the reception processing by the terminal apparatus 14 according to the modification is the same as in the flowchart of FIG. 23. In the modification, the processing contents of the packet signals according to the priority orders in step S16 in the flowchart of FIG. 23 are different.

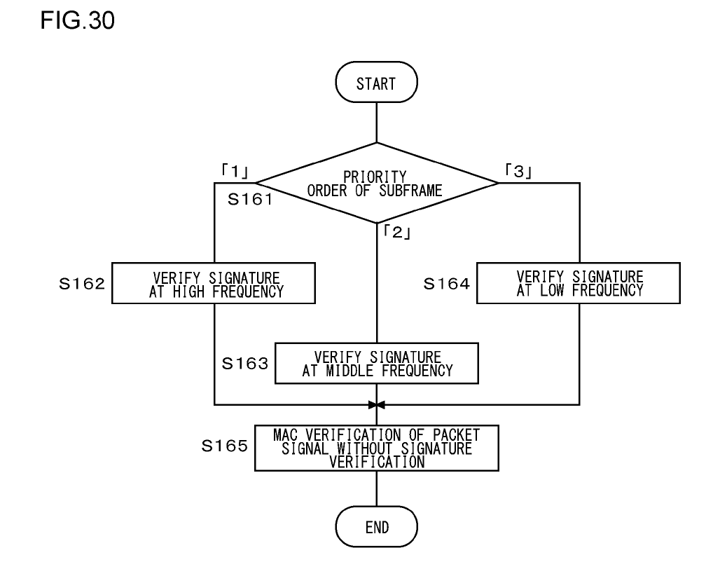

FIG. 30 is a flowchart illustrating a procedure of processing a packet signal in a priority order according to the modification. The determination unit 88 refers to the priority order given to the subframe receiving the RSU packet signal by the priority order determination unit 84 (S161). The determination unit 88 causes the security processing unit 58 to verify the electronic signature contained in the security footer of the RSU packet signal received in the subframe with the priority order “1” at a high frequency (S162). That is, the electronic signature verification is less thinned in the RSU packet signals from the base station apparatus 10 positioned in a near distance. The determination unit 88 causes the security processing unit 58 to verify the electronic signature contained in the security footer of the RSU packet signal received in the subframe with the priority order “2” at a middle frequency (S163). The determination unit 88 causes the security processing unit 58 to verify the electronic signature contained in the security footer of the RSU packet signal received in the subframe with the priority order “3” at a low frequency (S164). That is, the electronic signature verification is more thinned in the packet signals from the base station apparatus 10 positioned in a far distance.

The determination unit 88 determines a thinning rate and a thinning timing for assigning the priority order “1”, the priority order “2” and the priority order “3” according to the number of processable subframes or the number of decryptable ECDSA in the superframe. For example, the electronic signature contained in the RSU packet signal received in the subframe with the priority order “1” is verified once per 100 msec, the electronic signature contained in the RSU packet signal received in the subframe with the priority order “2” is verified once per 1 sec, and the electronic signature contained in the RSU packet signal received in the subframe with the priority order “1” is verified once per minute.

The determination unit 88 causes the security processing unit 58 to verify MAC added to the security footer for the RSU packet signal for which the electronic signature verification is skipped (S165). The MAC verification does not use ECDSA, and thus does not increase the loads of the ECDSA core. The MAC verification uses AES, but the processing loads of AES are low.

There has been described that the data authentication processing unit 64 in the terminal apparatus 14 performs the verification processing on the electronic signature contained in the security footer. More strictly, the data authentication processing unit 64 performs both the verification of the public key certificate contained in the security header and the verification of the electronic signature contained in the security footer.

The data authentication processing unit 64 verifies the electronic signature contained in the public key certificate contained in the RSU packet signal transmitted from the base station apparatus 10 by use of the authentication key (public key). The authentication key may be previously incorporated or may be acquired later with a safe means. The electronic signature of the public key certificate employs ECDSA similar to the electronic signature of “payload.”

When the electronic signature contained in the public key certificate is successfully verified, the public key generated by the base station apparatus 10 contained in the public key certificate can be estimated to be true based on the demonstration by the certificate authority. However, since the signature employs ECDSA, the processing loads increase when the public key certificates for all the RSU packet signals are verified. The public key certificate verification is skipped as needed. For example, only the public key certificate contained in the RSU packet signal first received in the service area of a base station apparatus 10 is verified, and only the digest held in the storage region described later is compared for the subsequent RSU packet signals, and when matched, “electronic signature” of FIG. 29 is verified.

The data authentication processing unit 64 holds the digest acquired from the successfully-verified public key certificate as a certificate verification log in a predetermined storage region. The digest is a hash value of data to be subjected to the electronic signature of the public key certificate, or its part. Instead of the digest, the serial number (identification information), the electronic signature, the public key and the apparatus ID contained in the public key certificate may be used. The storage region is formed by a FIFO-system RAM, and has a region for storing items of data more than the maximum number of RSU slots. In the present embodiment, since the superframe contains 16 subframes, the maximum number of RSU slots is 16.

When receiving the packet signal transmitted from the base station apparatus 10, the data authentication processing unit 64 compares the digest extracted from the public key certificate contained in the RSU packet signal with the digest held in the storage region. When both match, the verification of the public key certificate contained in the RSU packet signal is skipped. That is, success verification is assumed without proper verification and with a match of the digest of the public key certificate. This is because while the digest of the public key certificate matches, the packet signal transmitted from the same base station apparatus 10 is estimated. That is, once the public key certificate contained in the packet signal broadcasted from a base station apparatus 10 is successfully verified, the subsequent packet signals broadcasted from the base station apparatus 10 are determined to be highly reliable.

The data authentication processing unit 64 verifies the authenticated message contained in the RSU packet signal for which the digest of the public key certificate matches. The verification employs the public key and the apparatus ID contained in the received public key certificate. In the present embodiment, a verification is made as to whether “payload” in the message form with an electronic signature is true. For the encrypted message form with an electronic signature, the code is decrypted and then the same processings are performed. Since the electronic signature is generated by the private key paired with the public key stored in the public key certificate contained in the packet signal, if the message with the electronic signature using the public key is successfully verified, the message can be estimated to be generated by the base station apparatus 10 and to be true.

However, since the electronic signature employs ECDSA, if the messages with the electronic signature are verified in all the RSU packet signals, the processing loads increase. Thus, the verification of the electronic signature contained in the security footer is skipped for the packet signal for which the public key certificate is verified. The thinning processing is performed.

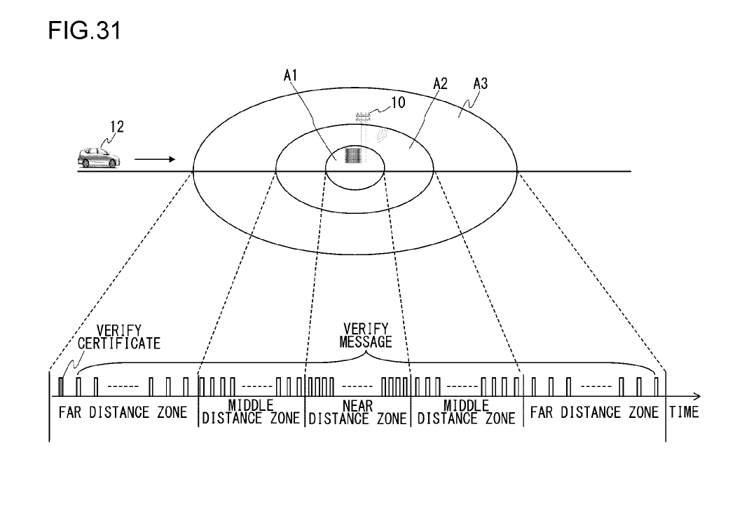

FIG. 31 is a diagram (1) for explaining a priority order switch processing. The vehicle 12 mounts the terminal apparatus 14 thereon. In FIG. 31, the vehicle 12 travels from “west” to “east.” The base station apparatus 10 as a roadside apparatus is installed in the travelling direction of the vehicle 12. The determination unit 88 in the terminal apparatus 14 sets a near distance area A1, a middle distance area A2, and a far distance area A3 around the base station apparatus 10 in the service area of the base station apparatus 10 based on the position information on the base station apparatus 10 contained in the packet signal received from the base station apparatus 10.

When the vehicle 12 enters the far distance area A3, the data authentication processing unit 64 in the terminal apparatus 14 receives a RSU packet signal from the base station apparatus 10. The data authentication processing unit 64 verifies the public key certificate contained in the security header of the first-received RSU packet signal. For the subsequent RSU packet signals, the comparison of the digest of the public key certificate and the message verification are performed. The electronic signature contained in the security footer of the RSU packet signal is verified at a frequency at which the priority order is set at “3” in the far distance area A3.

When the vehicle 12 further travels and enters the middle distance area A2, the data authentication processing unit 64 verifies the electronic signature contained in the security footer of the RSU packet signal at a frequency at which the priority order is set at “2.” When the vehicle 12 further travels and enters the near distance area A1, the data authentication processing unit 64 verifies the electronic signature contained in the security footer of the RSU packet signal at a frequency at which the priority order is set at “1.” When the vehicle 12 passes the base station apparatus 10 and reenters the middle distance area A2, the data authentication processing unit 64 verifies the electronic signature contained in the security footer of the RSU packet signal at a frequency at which the priority order is set at “2.” When the vehicle 12 further travels and reenters the far distance area A3, the data authentication processing unit 64 verifies the electronic signature contained in the security footer of the RSU packet signal at a frequency at which the priority order is set at “3.” When the vehicle 12 further travels and exits the service area of the base station apparatus 10, it cannot receive a packet signal from the base station apparatus 10 and its verification processing also ends.

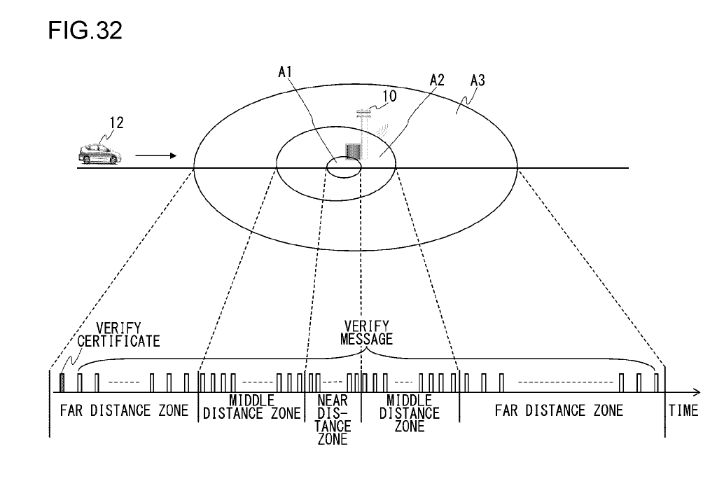

FIG. 32 is a diagram (2) for explaining the priority order switch processing. FIG. 32 is basically the same as FIG. 31, but the near distance area A1 and the middle distance area A2 are set at different positions. The determination unit 88 sets the near distance area A1, the middle distance area A2 and the far distance area A3 in the service area of the base station apparatus 10 based on the position information on the base station apparatus 10 contained in the packet signal received from the base station apparatus 10. At this time, the far distance area A3 is set around the base station apparatus 10. The near distance area A1 and the middle distance area A2 are set to be closer to the vehicle 12 than to the base station apparatus 10. Thereby, the priority order of the base station apparatus 10 positioned in the travelling direction of the vehicle 12 is easily raised.

According to the embodiment of the present invention, since the payload and the security footer are encrypted but the security header is not encrypted in the security frame, the contents of the security header can be acquired earlier. The contents of the security header can be acquired earlier and thus the reception processing can be speeded up. The priority orders are given to the subframes and a packet signal received in a subframe with a high priority order is preferentially processed, thereby reducing the number of packet signals to be processed. The number of packet signals to be processed is reduced and thus the number of ECDSA verification processings can be reduced.

The number of ECDSA verification processings is reduced and thus the verification of a message with an electronic signature can be completed within a predetermined period of time. The priority orders are given such that as a distance from each base station apparatus is shorter, the priority order is higher, and thus a packet signal from a near base station apparatus can be easily received. A packet signal from a near base station apparatus is easily received, and thus a reception quality of the packet signal can be enhanced. The priority orders are given such that as the reception power is higher, the priority order is higher, and thus a packet signal is easily received from a near base station apparatus.

When the verification processing performed on the electronic signature contained in the packet signal is invalid, the processing on the subframe receiving the packet signal is excluded from the next superframe, and thus a false base station apparatus can be ignored. A superframe is divided into a plurality of zones and the priority orders are given to the respective zones, and thus the timings of the ECDSA verification processings can be dispersed. The timings of the ECDSA verification processings are dispersed and thus the processings can be dispersed.

The thinning rate of the electronic signature verification is adjusted according to the priority order, thereby performing the reception processing more flexibly. The electronic signature and the MAC are used together in the road-to-vehicle communication, and thus the RSU packet signals which are not subjected to the reception processing can be reduced. The verification result of the public key certificate is left in the log, and thus the number of times of the certificate verification can be reduced.

The present invention has been described above by way of the embodiment. The embodiment is exemplary, and those skilled in the art may understand that various modifications of combination of the components and the processes are possible and such modifications are also encompassed in the scope of the present invention.

According to the modification of the present invention, the position information on the base station apparatus 10 is contained in the security header. However, the position information on the base station apparatus 10 is not limited thereto, and may be contained in other part. According to the modification, a degree of freedom for the design of the communication system 100 can be enhanced.

In another modification or still another modification of the present invention, the priority order determination unit 84 gives the priority orders based on the reception power. However, the priority order determination unit 84 is not limited thereto, and may give the priority orders based on the distance from each base station apparatus 10 similarly as in the embodiment. According to the modification, a degree of freedom for the design of the communication system 100 can be enhanced.

In still another modification of the present invention, a superframe is divided into two zones. The superframe is not limited thereto, and may be divided into three or more zones. According to the modification, a degree of freedom for the design of the communication system 100 can be enhanced.

What is claimed is:

1. A terminal apparatus comprising:
a reception unit configured to periodically receive a packet signal from a base station apparatus in each of two or more subframes in a superframe formed by time-multiplexing the subframes;
an analysis unit configured to give a priority order to a subframe receiving the packet signal from the base station apparatus based on the packet signal received in the reception unit; and
a processing unit configured to preferentially process the packet signal received in the subframe with a high priority order among the priority orders given in the analysis unit.

2. The terminal apparatus according to claim 1, wherein
position information on a apparatus as a transmission source is contained in the packet signal received in the reception unit,
the terminal apparatus further comprises an acquisition unit that acquires position information on the terminal apparatus, and
the analysis unit gives priority orders based on the position information on the transmission source contained in the packet signal received in the reception unit and the position information acquired in the acquisition unit.

3. The terminal apparatus according to claim 1, wherein
the terminal apparatus further comprises a measurement unit that measuring reception power per subframe, and the analysis unit gives priority orders based on the reception power measured in the measurement unit.

4. The terminal apparatus according to claim 1, wherein
the analysis unit divides a plurality of subframes contained in a superframe into two or more groups, and independently gives priority orders per divided group.

5. The terminal apparatus according to claim 1, wherein
the processing unit sets a verification timing per subframe from the base station apparatus at a thinning rate depending on the priority order given per subframe from the base station apparatus in the analysis unit, and performs a verification processing on an electronic signature contained in the packet signal received in the subframe from the base station apparatus at the verification timing.

6. The terminal apparatus according to claim 5, wherein
the processing unit further performs a public key certificate verification processing, and performs either one of the public key certificate verification processing and the electronic signature verification processing at the verification timing.

7. The terminal apparatus according to claim 1, wherein
the processing unit performs the verification processing on an electronic signature contained in a packet signal, and
when the verification processing performed in the processing unit is determined to be invalid, the analysis unit lowers a priority order of a subframe receiving the packet signal among the subframes contained in a next superframe.

8. A communication apparatus comprising:
a generation unit configured to generate an electronic signature by a private key based on at least a security header and a payload;
an encryption unit configured to perform an encryption processing on at least the payload and a security footer; and
an output unit configured to output a security frame in which at least the security header, the payload and the security footer are arranged, wherein
the security header to be subjected to an electronic signature to be generated by the generation unit contains a public key certificate, and the private key corresponding to the public key certificate is used for generating the electronic signature,
the encryption unit excludes the security header from the encryption processing, and the security footer contains the electronic signature generated in the generation unit, and
the encryption processing is performed on the payload and the security footer in the security frame output from the output unit by the encryption unit.
